(19) United States
(12) Patent Application Publication
(10) Pub. No.: US 2004/0002862 A1
(43) Pub. Date: Jan. 1, 2004

(54) Voice recognition device, observation probability calculating device, complex fast fourier transform calculation device and method, cache device, and method of controlling the cache device

(75) Inventors: Jong-ho Kim, Seoul (KR); Hyun-woo Park, Suwon-city (KR); Tae-su Kim, Suwon-city (KR); Mi-jung Noh, Yongin-city (KR); Byung-ho Min, Seoul (KR); Ki-won Jo, Yongin-city (KR); Sung-hwan Jo, Suwon-city (KR); Seung-hwan Lee, Suwon-city (KR); Jin-won Jeong, Suwon-city (KR); Ho-rang Jang, Bucheon-city (KR); Sun-hee Park, Yongin-city (KR); Keun-cheol Hong, Suwon-city (KR); Sung-jae Kim, Suwon-city (KR)

Correspondence Address: F. Chau & Associates, LLP, Suite 501, 1900 Hempstead Turnpike, East Meadow, NY, 11554, US

(73) Assignee: Samsung Electronics Co., Ltd.

(21) Appl. No.: 10/452,431

(22) Filed: May 30, 2003

(30) Foreign Application Priority Data
Jun. 28, 2002 (KR) 2002-37052
Aug. 12, 2002 (KR) 2002-47581
Aug. 12, 2002 (KR) 2002-47582
Aug. 12, 2002 (KR) 2002-47583

(51) Int. Cl. G10L 15/00

(52) U.S. Cl. 704/249

(57) ABSTRACT

A voice recognition device including dedicated arithmetic calculating modules for arithmetic operations that are more frequently required among arithmetic operations necessary for voice recognition, an observation probability calculating device for calculating probabilities that each of the phonemes of a pre-selected word can be observed upon voice recognition, a complex Fast Fourier Transform (FFT) calculation device and method of calculating a complex FFT of complex data, a cache, and a cache controlling method are provided. The arithmetic modules interpret commands received from a receiver and perform operations indicated by the commands.

### BACKGROUND OF THE INVENTION

1. Field of the Invention

The present invention relates generally to the field of voice recognition devices, and more particularly, to a voice recognition device including dedicated arithmetic calculating modules for arithmetic operations, an observation probability calculating device for calculating probabilities that phonemes of each syllable of a pre-selected word can be observed upon voice recognition, a complex Fast Fourier Transform (FFT) calculation device and method of performing complex FFT on complex data, a cache device and a method of controlling the cache device.

2. Description of the Related Art

Voice recognition can be applied to most electronic products used in the daily life of human beings. The realm of applications of voice recognition began with inexpensive electronic toys and is now anticipated to extend to complex, high-tech computer applications.

International Business Machines Corporation (IBM) initially proposed a technique for the utilization of voice recognition and proved the efficiency of voice recognition by applying a hidden Markov model to voice recognition, as disclosed in U.S. Pat. No. 5,636,291, issued Jun. 3, 1997).

The voice recognition device disclosed in U.S. Pat. No. 5,636,291 includes a pre-processor, a front-end unit, and a modeling unit. The re-processor identifies lexemes of all characters of interest. The front-end unit extracts feature values or parameters from the recognized lexemes. The modeling component performs a training phase in order to generate a model serving as a precise judgment standard for the next recognized character based on the extracted feature values or parameters. In addition, the modeling unit determines, based on the recognized lexemes, which character among pre-assigned characters should be determined as a recognized character.

Later, IBM also disclosed a voice recognition system and method using a hidden Markov model, which can be utilized more extensively, in U.S. Pat. No. 5,799,278, issued Aug. 25, 1998. The voice recognition system and method for isolated words uses a hidden Markov model, which is trained to recognize phonetically dissimilar words and adapted to recognize a number of words.

A voice recognition system can be constructed in software or in hardware. In a voice recognition software system, a voice recognition program is installed, and a processor is used. This software system requires a large amount of processing or calculating time, but is flexible so that functions can be easily changed.

A dedicated hardware device may also be used in a voice recognition hardware system. This system provides a faster processing speed and smaller power consumption than the voice recognition software system. However, the hardware system uses dedicated circuitry and a function change is very difficult.

Therefore, a need exists for a voice recognition device that enables fast processing as in a voice recognition hardware system while facilitating function changes as in a voice recognition software system.

### SUMMARY OF THE INVENTION

According to an embodiment of the present invention, a voice recognition device which provides a fast processing speed although processing data in a software fashion using a general processor is provided.

According to another embodiment of the present invention, an observation probability arithmetic unit suitable for a voice recognition device is provided.

According to a further embodiment of the present invention, an improved complex Fast Fourier Transform (FFT) calculation device suitable for a voice recognition device is provided.

In another embodiment, a complex FFT calculating method suitable for a complex FFT calculation device is provided.

According to a further embodiment of the present invention, a computer program-recording medium suitable for a complex FFT calculation device is provided.

In yet another embodiment of the present invention, a cache device suitable for a voice recognition device is provided.

In a further embodiment of the present invention, an improved method of controlling updating of the cache device in a hardware or software fashion is provided.

According to an aspect of the present invention, there is provided a voice recognition device which extracts a determined sound section from an input voice signal, extracts feature values used for voice recognition from the determined sound section, compares the feature values with feature values of a pre-stored word, and recognizes a word having the greatest probability as an input voice. The voice recognition device includes a coder/decoder (CODEC), a register file unit, a fast Fourier transform (FFT) unit, an observation probability calculation module, a program memory, and a control unit. The CODEC samples a voice signal received from a microphone and blocks and outputs sampled data at intervals of a predetermined time. The register file unit buffers data blocks received from the CODEC that correspond to the determined sound section. The FFT unit either transforms the data blocks received from the register file unit into a frequency domain or performs an inverse operation to the conversion into the frequency domain and stores the result of the conversion in the register file module. The observation probability calculation module calculates an observation probability by comparing the feature values extracted from the input voice signal with the feature values of phonemes of a pre-stored word on the basis of a frequency spectrum obtained by the FFT. The program memory extracts data blocks that correspond to the determined sound section from the data blocks output from the CODEC, stores the extracted data blocks in the register file unit, calculates feature values for a hidden Markov model from the frequency spectrum stored in the register file unit, and stores a voice recognition program based on observation probabilities of individual phonemes calculated by the observation probability calculation module. The control unit controls operations of the above constituent elements of the voice recognition device using the voice recognition program stored in the program memory.

A voice recognition device according to an embodiment of the present invention includes dedicated arithmetic devices for performing an observation probability calculation and an FFT calculation, which occupy a high percentage of calculations performed in a voice recognition system, independently of a processor. The arithmetic devices interpret commands from the processor and execute instructed operations.

### BRIEF DESCRIPTION OF THE DRAWINGS

The above aspects and advantages of the present invention will become more apparent by describing in detail-preferred embodiments thereof with reference to the attached drawings in which:

FIG. 1 is a block diagram showing a structure of a general voice recognition system;

FIG. 2 illustrates a method of obtaining a state sequence for a syllable;

FIG. 3 illustrates a word recognition process;

FIG. 4 is a block diagram showing a structure of a voice recognition device according to an embodiment of the present invention;

FIG. 5 is a block diagram illustrating a process of receiving a control command and data in the voice recognition device of FIG. 4;

FIG. 6 is a timing diagram illustrating a process a process of receiving a control command and data in the voice recognition device of FIG. 4;

FIG. 7 is a block diagram showing a structure of an observation probability calculation device used in a voice recognition device according to an embodiment the present invention;

FIG. 8 is a view for facilitating understanding of selection of a bit resolution;

FIG. 9 shows the fundamental structure of a device for performing a complex FFT of a radix 2;

FIG. 10 is a block diagram showing a structure of a complex FFT (fast Fourier transform) calculation device used in a voice recognition device according to an embodiment of the present invention;

FIG. 11 is a timing diagram for illustrating the operation of the complex FFT calculation device of FIG. 10;

FIG. 12 is a flowchart illustrating a block-fixed algorithm;

FIG. 13 is a flowchart illustrating a coefficient-fixed algorithm;

FIG. 14 is a timing diagram for illustrating execution of an FFTFR (FFT Front Real) command;

FIG. 15 is a timing diagram for illustrating execution of an FFTSR (FFT Secondary Real) command;

FIGS. 16A and 16B show an example of a conventional FFT calculation device;

FIG. 17 shows another example of a conventional FFT calculation device;

FIG. 18 shows still another example of a conventional FFT calculation device;

FIG. 19 shows yet another example of a conventional FFT calculation device;

FIG. 20 shows the results of an FFT calculation of a 256-point data block using the complex FFT calculation device of FIG. 10;

FIGS. 21A and 21B are block diagrams for illustrating a method of controlling a cache device used in a voice recognition device according to an embodiment of the present invention;

FIG. 22 is a block diagram of a cache device used in a voice recognition device according to an embodiment of the present invention;

FIG. 23 shows stored contents of an internal memory in the cache device of FIG. 22;

FIG. 24 is a block diagram showing the comparator of FIG. 22 in greater detail;

FIG. 25 is a block diagram for illustrating the operation of the address transformer of FIG. 22;

FIG. 26 is a block diagram showing a structure of the instruction word controller of FIG. 22;

FIG. 27 is a flowchart illustrating an operation of the cache device of FIG. 22 in a hardware control mode;

FIG. 28 is a flowchart illustrating an operation of the cache device of FIG. 22 in a software control mode;

FIG. 29 shows an example of an instruction word for block exchange;

FIG. 30 shows examples of construction of the bus interface (I/F) of FIG. 22;

FIG. 31 shows an example of a conventional cache;

FIG. 32 shows another example of a conventional cache;

FIG. 33 shows still another example of a conventional cache; and

FIG. 34 shows yet another example of a conventional cache.

### DETAILED DESCRIPTION OF PREFERRED EMBODIMENTS

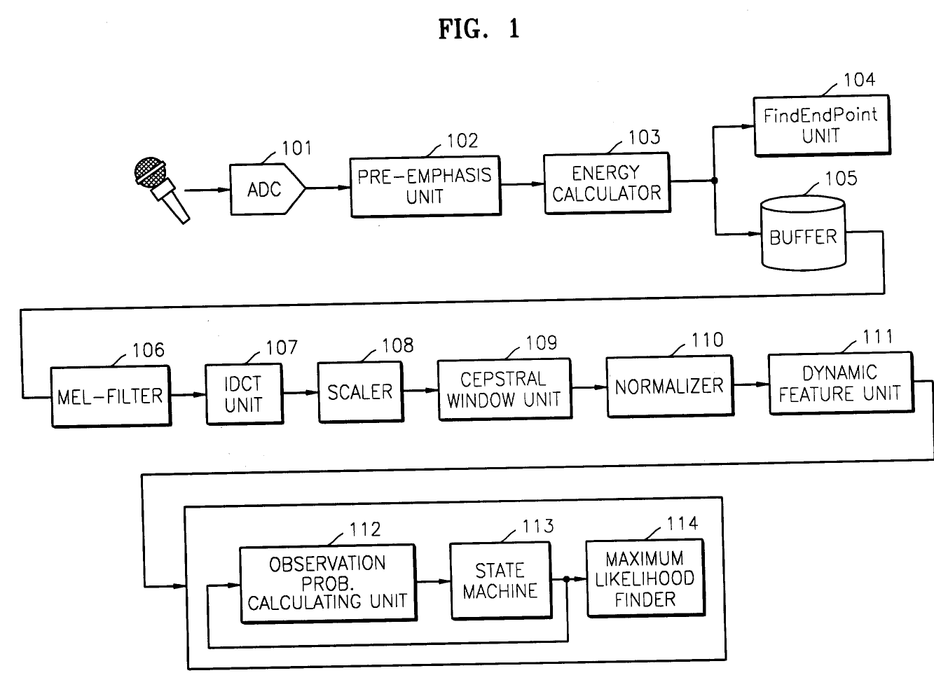

FIG. 1 is a block diagram showing a structure of a general voice recognition system. In FIG. 1, an analog-to-digital converter (ADC) 101 converts a sequential voice signal into a digital signal so that the voice signal is easily calculated.

A pre-emphasis unit 102 emphasizes a high-frequency component of a voice to clearly distinguish pronunciations. The digital voice signal is divided and processed in units of a predetermined number of samplings. For example, the digital voice signal is divided in units of 240 samples (30 ms).

Since cepstrum and energy produced from a frequency spectrum are generally used as feature vectors in a Hidden Markov model, they need to be calculated. An energy calculation block 103 calculates this energy and cepstrum. To obtain energy, the energy calculator 103 calculates instantaneous energy for 30 ms using an energy calculation formula in the timing domain. The energy calculation formula is Equation 1:

$$Y ( i ) = \sqrt{\frac{{\sum }_{j = 0}^{239} {( X ( W\_RATE \cdot i + f ) )}^{2}}{W\_SIZE}} , 0 \leq j \leq 239 \qquad ( 1 )$$

n energy value calculated using Equation 1 is used to determine whether a currently input signal is a voice signal or noise. To calculate a spectrum in the frequency domain, fast Fourier transform (FFT) is widely used in signal processing. Such an FFT calculation can be expressed in Equation 2:

$$X ( k ) = \sum [ x ( n ) cos ( \frac{2 π}{256} kn ) + y ( n ) sin ( \frac{2 π}{256} kn ) ] + jSUM [ y ( n ) cos ( \frac{2 π}{256} kn ) - x ( n ) sin ( \frac{2 π}{256} kn ) ] \qquad ( 2 )$$

If it is determined based on the energy calculation result that the current input signal is a voice signal, the beginning and end of the voice signal must be determined, which is performed in a FindEndPoint unit 104. In this way, if an effective word is determined, only spectrum data corresponding to the determined effective word is stored in a buffer 105. Accordingly, the buffer 105 stores only an effective voice signal obtained by removing noise from a word voiced by a speaker.

A mel-filter 106 performs mel filtering, which is a pre-processing step to obtain a cepstrum by filtering a spectrum using a bandwidth of 32 bands.

Through mel-filtering, a spectrum value for 32 bands is calculated. By transforming the calculated spectrum value in the frequency domain into a spectrum value in the timing domain, a cepstrum, which is a parameter used in hidden Markov models, is obtained. The transformation of the frequency domain into the timing domain is performed using an Inverse Discrete Cosine Transform (IDCT) in an IDCT unit 107.

Since the obtained cepstrum and energy values, which are used for a speech recognition using a hidden Markov model, have a significantly big difference (i.e., about 10²), they need to be adjusted. This adjustment is performed using a logarithm operation in a scaler 108. A cepstral window unit 109 separates periodicity and energy from the mel-cepstrum value and improves noise characteristics using Equation 3:

Y[l][j]=Sin_TABLE[j] [symbol] X([l][j+1]) here, 0 [symbol] i<NoFrames, 0 [symbol] j [symbol] 7 (3)

wherein NoFrames denotes the number of frames. Sin_TABLE can be obtained using Equation 4:

$$Sin\_TABLE [ j ] = i + 4 \cdot Sin ( \frac{π \cdot ( J + 1 )}{8} ) \qquad ( 4 )$$

After the above calculation, a normalizer 110 normalizes energy values, which are ninth data in each frame, into values existing within a predetermined range. To achieve normalization, first, the largest value is searched among the ninth data of each frame using Equation 5:

$$MaxEnergy = {Max}_{0 \leq i < NoFrames} WindCepstrum [ i ] [ 8 ] \qquad ( 5 )$$

Then, normalized energy is obtained by subtracting the largest value from the energy data of all frames as shown in Equation 6:

Cepstrum [i][8]=(WindCepstrum [i][8]−MaxEnergy)·WEIGHT_FACTOR where 0≦i<NorRam (6)

A recognition rate of voice recognition is generally heightened by increasing the types of parameters (e.g., feature values). To do this, in addition to a feature of each frame, the difference in feature values between frames is taken as another feature. A dynamic feature unit 111 calculates such a delta cepstrum and determines the calculated delta cepstrum to be a feature value. The difference between cepstrums is calculated using Equation 7:

$$Rcep ( i ) = F ( i ) = \frac{1}{\sqrt{10}} ( 2 \cdot Scep [ i + 4 ] [ j ] + 1 \cdot Scep [ i + 3 ] [ j ] + 0 \cdot Scep [ i + 2 ] [ j ] - 1 \cdot Scep [ i + 1 ] [ j ] - 2 \cdot Scep [ i ] \qquad ( 7 )$$

In general, such a calculation operation is performed on two adjacent frames. If this calculation is completed, an equal number of delta cepstrums to the number of cepstrums are produced. Through the above operations, feature values used in a word search using a hidden Markov model are extracted.

Based on the extracted feature values, a word search using a predetermined hidden Markov model is performed through the following three steps. The first step is performed in an observation probability-calculating unit 112. Basically, a search and determination process is based on probabilities. That is, the most similar syllable to a spoken word, which is determined based on probabilities, is searched. The types of probability include an observation probability and a transition probability, which are accumulated and used to select a syllable sequence having the greatest probability. The observation probability can be obtained using Equation 8:

$$o\_prob [ m ] = {Max}_{0 \leq i \leq 9} {dbx}_{0} [ i ] + {Max}_{0 \leq i \leq 9} {dbx}_{1} [ i ] \text{where} \\ ( status [ m ] = 1 ) , 0 \leq m \leq s \qquad ( 8 )$$

wherein dbx denotes a probabilistic distance between a reference mean value and each of the feature values extracted from an input signal. As the probabilistic distance becomes smaller, the observation probability increases. The probabilistic distance is obtained using Equation 9:

$${dx}_{0} [ i ] = lw - \frac{{\sum }_{j = 0}^{8} p [ i ] [ j ] \cdot {( m [ i ] [ j ] - Feature [ k ] [ 0 ] [ j ] )}^{2}}{2} \\ {dx}_{1} [ i ] = lw - \frac{{\sum }_{j = 0}^{8} p [ i ] [ j ] \cdot {( m [ i ] [ j ] - Feature [ k ] [ 1 ] [ j ] )}^{2}}{2} \qquad ( 9 )$$

wherein m denotes the mean value of a parameter, Feature denotes a parameter extracted from an input signal, p denotes a Precision value that represents a distribution degree (e.g., a dispersion, 1/σ²), lw denotes a log weight, and i denotes “a mixture” which represents a type of phoneme. If representative phoneme values, which are obtained from many people to increase the accuracy of recognition, are classified into several groups each including similar types of a phoneme, i serves as a factor that represents each group. In Equation 9, k denotes the number of frames, and j denotes the number of parameters. By reference, the number of frames varies depending on the type of a word, and the mixture can be classified into various types according to the type of pronunciation made by a human being. The log weight decreases while a calculation of a weight in a linear domain is changed into a weight calculation in a log domain.

The calculated observation probabilities correspond to probabilities that the phonemes of a pre-selected syllable of a word can be observed. The individual phonemes have different observation probability values. After observation probabilities for individual phonemes are determined, they are applied to a state machine 113, which obtains the most appropriate phoneme sequence. Each state sequence of a hidden Markov model for independent word recognition is formed based on feature values of each phoneme of a word desired to be recognized.

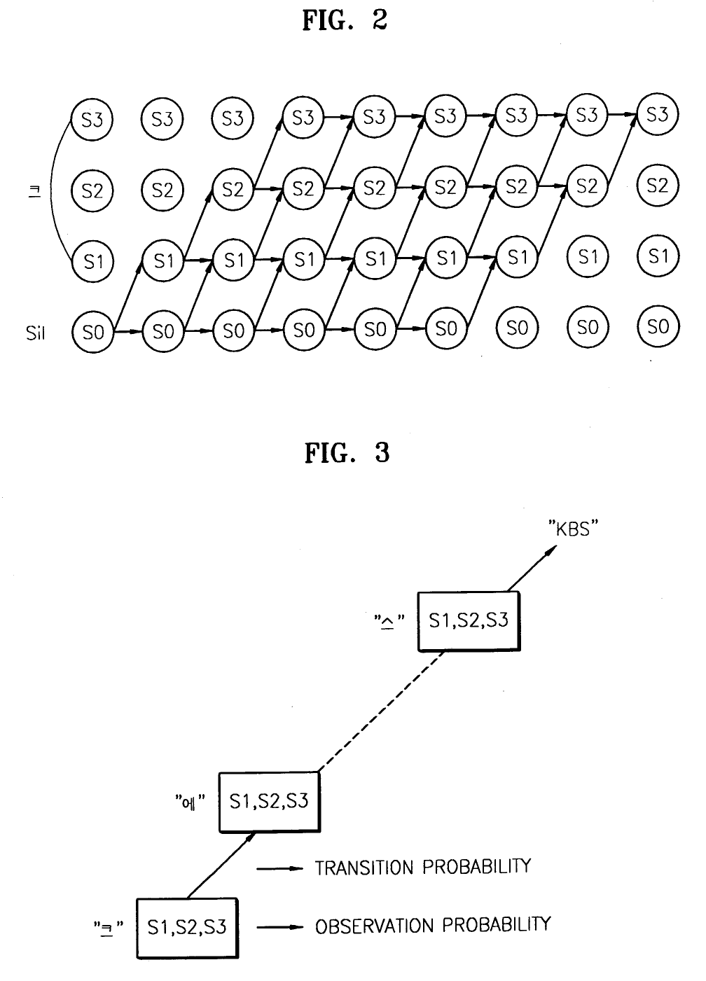

FIG. 2 illustrates a method of obtaining a state sequence of a syllable “ [symbol] ” (which is Korean). Assuming that a syllable “ [symbol] ” is composed of three states S1, S2, and S3, FIG. 2 shows a process in which a state starts from initial state SO, passes states S1 and S2, and finally reaches state S3. In FIG. 2, a right movement on the same state level denotes a delay, which is dependent on a speaker. In other words, a syllable “ [symbol] ” may be voiced for a very short period of time or for a relatively long period of time. As the time for which a syllable is voiced becomes longer, a delay on each state level becomes longer. In FIG. 2, Sil denotes a silent sound.

As shown in FIG. 2, many state sequences can exist for syllable “ [symbol] ” composed of 3 sequential states S1, S2, and S3, and a probability calculation is performed on each of the state sequences of an input signal. Thus, an amount of calculation is required.

When probability calculations for all phonemes (e.g., processing of the state sequences of individual phonemes) have been finally completed, a probability for each phoneme is obtained. In FIG. 2, state advancement is achieved in such a way that an Alpha value for each state is obtained and then a branch having the greatest Alpha value is selected. The Alpha value is obtained by accumulating previous observation probabilities and inter-phoneme transition probabilities pre-obtained through an experiment, using Equation 10:

$$State [ i ] . Alpha = {Max}_{0 \leq i < 277} State [ i ] . Alpha\_prev + State [ i ] . trans\_prob [ 0 ] , \\ State [ i - 1 ] . Alpha\_prev + State [ i ] . trans\_prob [ 1 ] + * ( State [ i ] . o\_prob ) \qquad ( 10 )$$

wherein State. Alpha denotes a current accumulated probability value, State.Alpha_prev denotes a previous accumulated probability value, trans_prob [0] denotes a probability that a state Sn is transited to the state Sn (e.g., S0→S0), trans_prob [1] denotes a probability that the state Sn is transited to a state Sn+1 (e.g., S0→S1), and o_prob denotes an observation probability calculated for a current state. A maximum likelihood finder 114 selects a word that is recognized based on a final accumulated probability value of each phoneme of Equation 10. A word having the greatest probability is selected as a recognized word.

A process of recognizing a spoken word “KBS” will now be described.

The word “KBS” is composed of three syllables of “ [symbol] [symbol] ”, “ [symbol] ”, and “ [symbol] [symbol] ”. Syllable “ [symbol] [symbol] ” has three phonemes of “ [symbol] ” “ [symbol] ”, and “ [symbol] ” syllable “ [symbol] ” has two phonemes of “ [symbol] ” and “ [symbol] ” and syllable “ [symbol] [symbol] ” has three phonemes of “ [symbol] ”, “ [symbol] ” and “ [symbol] ”.

Accordingly, word “KBS” is composed of 8 phonemes of “ [symbol] ” “ [symbol] ”, “ [symbol] ”, “ [symbol] ”, “ [symbol] ”, “ [symbol] ”, “ [symbol] ”, and “ [symbol] ” and recognized based on an observation probability for each of the 8 phonemes and a probability of transition between adjacent phonemes.

To correctly recognize the word “KBS”, the above 8 phonemes must be recognized as correctly as possible, and a word having the most similar phoneme sequence to that of the spoken word “KBS” must be selected.

First of all, an observation probability is calculated for each of the phonemes of an input voice signal. To achieve this, the degree of a similarity (e.g., a probability) of each phoneme to each of phoneme samples stored in a database is calculated, and a probability for the most similar phoneme sample is determined to be the observation probability for each phoneme. For example, a phoneme “ [symbol] ” is compared with phoneme samples stored in the database, and phoneme sample “ [symbol] ” having the greatest probability is selected.

If an observation probability for each of the phonemes of the input voice signal is calculated, that is, if a phoneme sample for each of the phonemes of the input voice signal is determined, the input voice signal is applied to a state sequence composed of the determined phoneme samples to determine the most appropriate sequence. The state sequence is composed of 8 phonemes “ [symbol] ”, “ [symbol] ”, “ [symbol] ”, “ [symbol] ”, “ [symbol] ”, “ [symbol] ”, “ [symbol] ”, and “ [symbol] ”. A sequence “KBS” having the greatest observation probability for each phoneme and the greatest accumulation of observation probabilities is selected. Each of the 8 phonemes is composed of three states.

FIG. 3 illustrates a word recognition process. To recognize a word “KBS”, the observation probability calculating device 112 calculates observation probabilities for 8 phonemes “ [symbol] ”, “ [symbol] ”, “ [symbol] ”, “ [symbol] ”, “ [symbol] ”, “ [symbol] ”, “ [symbol] ”, and “ [symbol] ”, and the state machine 113 selects a word “KBS” having the greatest observation probability for each phoneme and the greatest accumulated value of observation probabilities.

In general, many existing voice recognition products design the above-described operations in software (C/C++ language) or an assembly code and perform the functions using a general-purpose processor.

Alternatively, the existing voice recognition products can implement the above operations in dedicated hardware, e.g., an application specific integrated circuit (ASIC). These implementations of designing and performing the operations for voice recognition have advantages and disadvantages. The software implementation takes a relative long calculation time but is elastic enough to change the operations easily.

On the other hand, the dedicated hardware implementation provides a fast processing speed and a small amount of power consumption compared to the software implementation. However, this way is not elastic, so a change of the functions is impossible.

The present invention provides a voice recognition device that can provide a fast processing speed while being adapted to a software implementation that enables the functions to be easily changed.

In the software processing implementation in which a general-purpose processor is used, the number of calculations required to perform each of the functions is shown in Table 1. Here, the number of calculations is not the number of command words but the number of times of calculations, such as, a multiplication, an addition, a log, an exponent operation, and the like.

TABLE 1

| | Pre-processing | | | Mel-filtering & cepstrum | | | | HMM | | |
|---|---|---|---|---|---|---|---|---|---|---|
| | | Energy | | Mel- | | | | Observ. | State | |
| Calculation | Pre-emphasis | calc. | FFT | filtering | IDCT | Scaling | Cepstr. | Prob. | Machine | Total |
| Multiplication | 160 | 240 | 4096 | 234 | 288 | 9 | 36 | 43200 | 0 | 48,263 |
| Addition | 160 | 239 | 6144 | 202 | 279 | 0 | 1 | 45600 | 600 | 53,225 |
| Division | 0 | 1 | 0 | 0 | 0 | 0 | 9 | 0 | 0 | 10 |
| Extraction of | 0 | 1 | 0 | 0 | 0 | 0 | 0 | 0 | 0 | 1 |
| square root | | | | | | | | | | |
| Log | 0 | 0 | 0 | 32 | 0 | 0 | 0 | 1 | 1 | 33 |
| Total of | 329 | 481 | 10240 | 468 | 567 | 46 | 88800 | 601 | 601 | 101,532 |
| calculations | | | | | | | | | | |

As can be seen from Table 1, the total number of calculations required for general voice recognition is about 100,000, among which about 88.8% is performed during by an observation probability calculation and about 10.1% is performed during an FFT calculation.

Hence, if dedicated calculation devices perform calculations that occupy a high percentage of the total calculation of the entire system, such as, an observation probability calculation or an FFT calculation, the performance of the system is significantly improved. In other words, even a device that operates with a low clock can achieve an excellent voice recognition.

The present invention provides an improved voice recognition device which provides an improved voice processing speed by including dedicated calculation devices for performing an observation probability calculation and an FFT calculation.

The voice recognition device according to an embodiment of the present invention includes dedicated calculation devices for performing a barrel shift, a multiplication, an accumulation, and a square root extraction, as well as dedicated calculation devices for performing an observation probability calculation and an FFT calculation.

The voice recognition device according to an embodiment of the present invention operates in connection with an external computer and accordingly includes a memory interface device for receiving a program from the external computer or transmitting a voice recognition result to the external computer.

The voice recognition device according to an embodiment of the present invention includes a program memory for storing a program received from the external computer, a central processing unit (CPU), and a cache device for overcoming a deviation of a speed at which data stored in the program memory is processed.

A 3-bus system of 2Read-1 Write is widely used as the internal bus of a general-purpose processor. Accordingly, the voice recognition device according to embodiments of the present invention is designed to have a structure suitable for the 3-bus system.

In the voice recognition device according to embodiments of the present invention, constituent modules receive command words via a command word bus, and a decoder interprets the received command words and performs commanded operations.

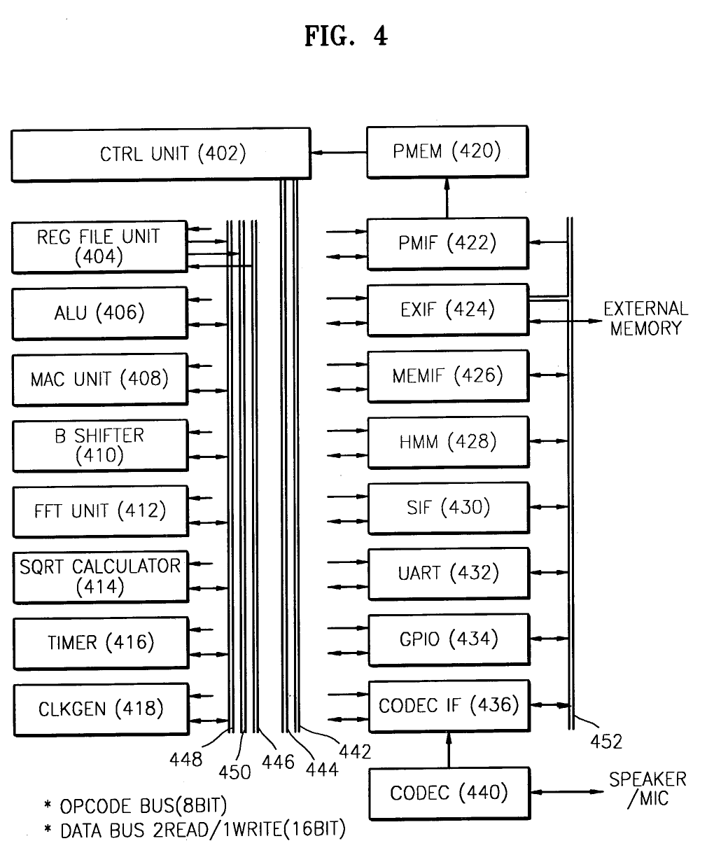

FIG. 4 is a block diagram showing a structure of a voice recognition device according to an embodiment of the present invention, which is a system-on-chip (SOC) device. The voice recognition device of FIG. 4 adopts a 3-bus system as a special purpose processor for speaker-independent voice recognition. Its constituent modules share two OPcode buses for 3 data buses (two read buses and one write bus).

Referring to FIG. 4, a control (CTRL) unit 402 is embodied by a general-purpose processor. A REG file unit 404 denotes a module for performing a register filing operation. An arithmetic logic unit (ALU) 406 denotes a module for performing an arithmetic logic operation. A Multiply and Accumulation (MAC) unit 408 denotes a module for performing a repetitive MAC required to compute an observation probability. A barrel (B) shifter 410 denotes a module for performing a barrel shifting operation. A fast Fourier Transform (FFT) unit 412 denotes a module for performing an FFT calculation according to the present invention. A square root (SQRT) calculator 414 denotes a module for performing a square root calculating operation. A timer 416 denotes a module for performing a timer function. A clock generator (CLKGEN) 418 denotes a module for generating a clock and controlling a clock speed to achieve low power consumption.

A PMEM 420 denotes a program memory module, a PMIF 422 denotes a program memory interface module, an EXIF 424 denotes an external interface module, a MEMIF 426 denotes a memory interface module, an HMM 428 denotes a hidden Markov model calculation module, an SIF 430 denotes a synchronous serial interface module, an UART 432 denotes a universal asynchronous receiver/transmitter module, a GPIO 434 denotes a general-purpose input/output module, a CODEC IF 436 denotes a codec interface module, and a CODEC (coder/decoder) 440 denotes a module for performing a CODEC (coder/decoder) operation. An external bus 452 interfaces data with an external memory. The EXIF 424 supports a dynamic memory access (DMA). Although not shown in detail in FIG. 4, the buses 442, 444, 446, 448, and 450 are connected to the modules 402 through 440.

An unshown controller (decoder) built in each of the constituent modules receives commands via dedicated command (OPcode) buses 448 and 450 and decodes the received commands. Data are provided via two read buses 442 and 444 or output via a write bus 446.

The voice recognition device of FIG. 4 includes the PMEM 420 into which a program is loaded via the EXIF 424.

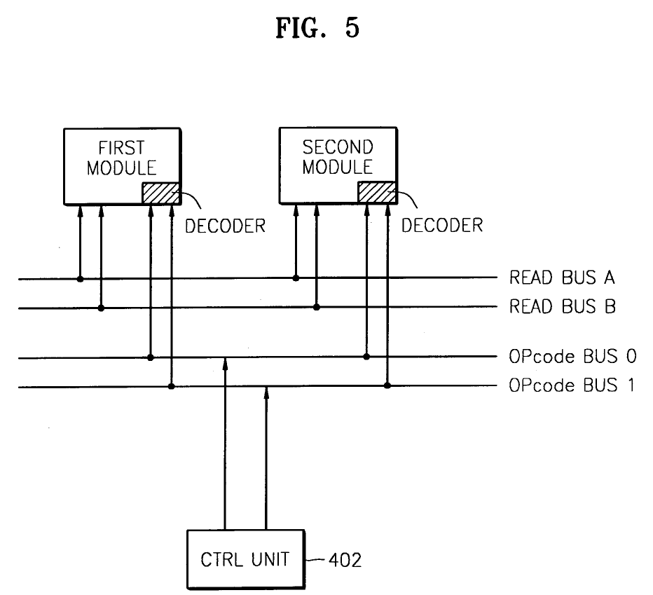

FIG. 5 is a block diagram illustrating a process of receiving a control command and data in the voice recognition device of FIG. 4. The control unit 402 directly decodes a control command and controls the constituent modules to execute an operation designated in the control command. Alternatively, the control unit 402 passes a control command to a constituent module via OPcode buses 0 and 1 (the OPcode buses 448 and 450) and indirectly controls the operation of each of the constituent modules. The constituent modules share the OPcode buses 0 and 1 and read buses A and B (the read buses 442 and 444).

To be more specific, to directly control execution of an operation, the control unit 402 fetches a control command from the PMEM 420, decodes the fetched control command, reads data necessary for an operation designated in the control command, and stores the read data in the REG file unit 404. Thereafter, if the designated operation is a control logic operation, it is performed in the ALU 406. If the designated operation is a multiplication and accumulation, it is performed in the MAC unit 408. If the designated operation is a barrel shifting, it is performed in the B shifter 410. If the designated operation is a square root extraction, it is performed in the SQRT extractor 414. The results of the designated operations are stored in the REG file unit 404.

To indirectly control the execution of an operation, the control unit 402 uses the OPcode buses 0 and 1. The control unit 402 sequentially applies a control command fetched from the PMEM 420 to the OPcode buses 0 and 1 without decoding the fetched control command.

The control command is first applied to the OPcode bus 0 and then applied to the OPcode bus 1 one clock after the first application of the control command. If a control command is applied to the OPcode bus 0, the constituent modules determine whether the applied control command is for themselves. If the constituent modules receive control commands corresponding to themselves, they decode their control commands using their built-in decoders and take a stand-by state for performing operations designated in the control commands. If the above control command is also applied to the OPcode bus 1 one clock after being applied to the OPcode bus 0, the operations designated in the control commands are performed for the first time. Unshown RT and ET signal lines are allocated to represent whether a control code applied to the OPcode buses 0 and 1 is enabled.

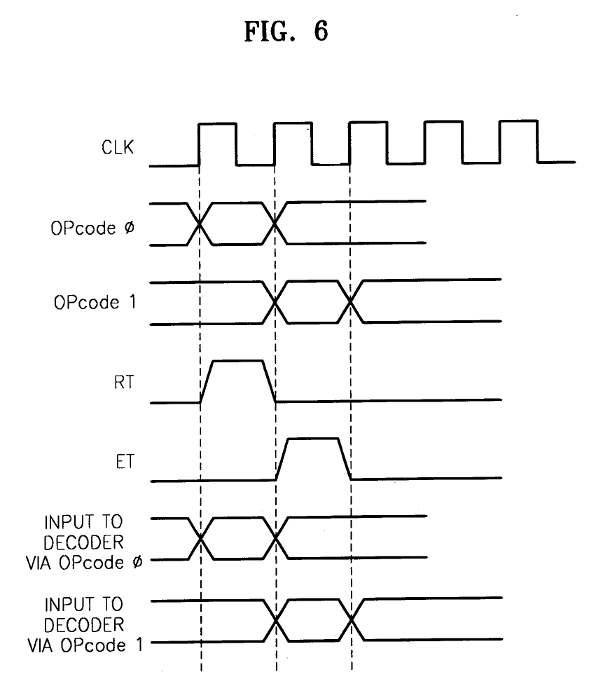

FIG. 6 is a timing diagram illustrating a process of receiving a control command and data in the voice recognition device of FIG. 4. Referring to FIG. 6, the top signal is a clock signal CLK, sequentially followed by a control command applied to the OPcode bus 0 (OPcode 448), a control command applied to the OPcode bus 1 (OPcode 450), an RT (Real Time) signal, an ET (Execution Time) signal, data applied to the read bus A, and data applied to the read bus B.

If a control command is applied to the OPcode bus 0 and the OPcode bus 0 is enabled by the RT signal, one of the constituent modules of FIG. 4 recognizes and decodes the control command and thus enters into a standby state. Thereafter, if the same control command is applied to the OPcode bus 1 and the OPcode bus 1 is enabled by the ET signal, the constituent module of interest performs an operation designated in the control command. To be more specific, the constituent module of interest receives data from the read buses A and B, performs the operation designated in the control command, and outputs the results of the operation via a write bus.

Voice recognition performed in the voice recognition device of FIG. 4 will now be described with reference to FIG. 1. Referring to FIG. 4, a voice signal received via a microphone (not shown) is converted into a digital signal in the CODEC 440 (see the ADC 101 of FIG. 1).

Sampled data obtained by the analog-to-digital conversion are blocked at intervals of a predetermined time, e.g., in units of 30 ms. If the sampled data generated on a time axis by being partially overlapped sequentially indicated by d0, d1, . . . , and the number of data points in a data block is given as 240, the sampled data are blocked while 80 sampled data of two adjacent data blocks overlap each other. For example, the first data block has d0 through d239, and the second data block has d80 through d319.

The reason why the data are blocked in such a way that some data of a current block is overlapped by some data of the next block is to reduce an error generated in a complex FFT calculation.

In a complex FFT calculation, the calculation speed can be increased by applying a data block to be currently calculated to the real part of the calculation and a data block to be next calculated to the imaginary part to obtain two FFT results at one time. Here, the data values applied to the real part must be similar to those applied to the imaginary part.

Sound data or image data, which satisfy a primary Markov model, is composed of data values similar to adjacent data values. Hence, sound data and image data are suitable for the above-described calculation method.

The duplicate allocation of data to two data blocks can further reduce the range of an error generated upon FFT calculation.

The CODEC IF 436 controls the operation of the CODEC 440.

As expressed in Equation 1, spontaneous energy for each block, e.g., 30 ms, is calculated. Addition, multiplication and accumulation, and square root extraction that are required to compute Equation 1 are performed in the ALU 406, the MAC unit 408, and the SQRT extractor 414 of FIG. 4, respectively.

Also, an FFT is calculated on each data block as expressed in Equation 2 in the FFT unit 412. Consequently, a spectrum of a frequency domain is obtained (see the energy calculator 103 of FIG. 1).

Using the obtained energy calculation result, the beginning and end of a voice signal, e.g., a word, is determined (see the FindEndPoint unit 104 of FIG. 1).

When an effective sound section, for example, an effective word, is determined, only spectral data corresponding to the effective sound section are buffered. The REG file unit 404 of FIG. 4 provides a storage space for buffering.

As a pre-processing step for obtaining a cepstrum from the spectral data, mel-filtering, which is filtering a spectrum with a bandwidth composed of 32 bands, is performed in the mel-filter 106 of FIG. 1. Consequently, a spectral value for each of the 32 bands is obtained.

A cepstrum, which is a parameter used in a hidden Markov model, can be obtained by transforming the obtained spectral values existing on the frequency domain into spectral values on the time domain. Since an IDCT operation performed to transform the frequency domain into the time domain corresponds to an inverse operation of an FFT operation, the IDCT operation can be performed using the FFT unit 412 of FIG. 4 in the IDCT unit 107 of FIG. 1.

The difference between the energy value and each of the cepstrum values is scaled in the scaler 108 of FIG. 1. Also, a separation of periodicity and energy from a mel-cepstrum value and a reduction of noise are performed using Equation 3 in the cepstral window unit 109 of FIG. 1.

When the above calculations are completed, energy values included in the ninth data of each frame are normalized to be within a predetermined range in the normalizer 110 of FIG. 1.

A normalized energy value can be obtained by searching for the maximum energy value among the ninth data of each frame as expressed in Equation 5 and subtracting the maximum energy value from the energy data of each frame as expressed in Equation 6.

A delta cepstrum is calculated using Equation 7 and selected as a feature value in the dynamic feature unit 111 of FIG. 1.

After these calculations, an equal number of delta cepstrums to the number of cepstrums are obtained.

Through this process, feature values used for a word search based on a hidden Markov model are extracted.

Using the extracted feature values, a word search using predetermined hidden Markov models is performed.

Observation probabilities are calculated using Equations 8 and 9 in the HMM 428 (see the observation probability calculating device 112 of FIG. 1). The calculated observation probabilities represent that the individual phonemes of a predetermined word can be observed. The phonemes have different probability values.

The MAC unit 408 operates in connection with the HMM 428 and alternately performs a multiplication and an accumulation to compute the observation probabilities.

When an observation probability for each of the phonemes within an effective sound section is determined, the observation probabilities are applied to a state sequence to obtain the most appropriate phoneme sequence, which is performed in the state machine 113 of FIG. 1.

Each of state sequences for hidden Markov models for independent word recognition is generally a sequence formed based on the feature values of each the phonemes of a word to be recognized.

When the probability calculations on every phoneme (e.g., state sequence processing for each phoneme) are completed, a probability value of individual phonemes is obtained. As shown Equation 10, a word recognized based on the accumulated final probability value of individual phonemes is selected. Here, a word having the greatest probability is selected as a recognized word in the maximum likelihood finder 114 of FIG. 1.

The voice recognition device of FIG. 4 operates according to a program stored in the PMEM 420. The PMIF 422, which is a cache memory, is provided to prevent the performance of the voice recognition device from being degraded due to the difference in data access speeds between the control (CTRL) unit 402 and the PMEM 420.

As described above, the voice recognition device according to an embodiment of the present invention enables frequently required calculations among calculations necessary for voice recognition to be performed in dedicated devices, thereby significantly improving the performance of the voice recognition device.

As can be seen from Table 1, the total number of calculations required for general voice recognition is about 100,000, among which observation probability calculations occupy about 88.8%.

If the above-described algorithm is installed and performed in a widely used ARM processor, which is a general-purpose processor, a total of approximately 36 million command words are processed. It has been found that about 33 million command words among the 36 million command words are used for a hidden Markov model search. Table 2 shows command words actually required to perform a voice recognition function using an ARM processor, in which the command words are classified by function.

TABLE 2

| | Cycle number of | |
|---|---|---|
| Function | command words | Percentage (%) |
| Observation probability | 22,267,200 | 61.7% |
| calculation | | |
| State machine updating | 11,183,240 | 30.7% |
| FFT calculation | 910,935 | 2.50% |
| Maximum likelihood | 531,640 | 1.46% |
| finding | | |
| Mel-filtering/IDCT/scaling | 473,630 | 1.30% |
| Dynamic feature | 283,181 | 0.78% |
| determination | | |
| Pre-emphasis & energy | 272,037 | 0.75% |
| calculation | | |
| Cepstral window & | 156,061 | 0.43% |
| normalization | | |
| End point finding | 123,050 | 0.30% |
| Total | 36,400,974 | 100.00% |

As can be seen from Table 2, approximately 62% of command words are required for observation probability calculation. Hence, a dedicated device is used as an observation probability calculator which processes the most number of command words, thereby improving a processing speed and reducing power consumption.

The present invention also provides a dedicated observation probability calculation device which can compute observation probabilities with a small number of command words, e.g., a small number of cycles.

To improve the efficiency of an observation probability calculation, the present invention also provides a device capable of calculating Equations 9 and 10, which are the most frequently-calculated probabilistic distance calculation formulae, using only one command word:

$$\frac{p [ i ] [ j ] \cdot {( mean [ i ] [ j ] - feature [ k ] [ j ] )}^{2}}{2} \qquad ( 11 )$$

wherein p[i][j] denotes a precision which represents a degree of distribution (dispersion, 1/σ²), mean[i][j] denotes a mean value of phonemes, and feature[k][j] is a parameter for a phoneme and denotes energy and cepstrum. In Equation 11, mean [i][j] [symbol] feature [k][j] represents the difference (distance) between the probabilistically input parameter of a phoneme and a pre-defined parameter sample. The result of mean [i][j] [symbol] feature [k][j] is squared to calculate absolute probabilistic distances. The square of mean [i][j] [symbol] feature [k][j] is multiplied by the dispersion, thus an objective real distance can be predicted. Here, the parameter samples are empirically obtained from many voice data. As the number of voice data obtained from a variety of people increases, a recognition rate is improved.

However, in the present invention, the recognition rate can be maximized by overcoming the restrictive chacteristics of hardware, e.g., a limit in data bits (16 bits), using Equation 12:

{P[i][j] [symbol] (mean[i][j] [symbol] feature[k][j])}² (12)

wherein p[i][j] denotes a distribution degree, 1/σ, which is different from the dispersion 1/σ² in Equation 11. The reason why the distribution degree, 1/σ, is used instead of the dispersion 1/σ², will now be described.

In Equation 9, m [i][j] [symbol] feature [i][j] is squared, and the square of m [i][j] feature [i][j] is multiplied by p [i][j]. However, in Equation 12, m [i][j] [symbol] feature [i][j] is multiplied by p [i][j], and the multiplication result is squared.

Also, in Equation 9, as high of a bit resolution as the square of m [i][j] [symbol] feature [i][j] is required to express p [i][j]. However, in Equation 12, only as much of a bit resolution as the value of m [i][j] [symbol] feature [i][j] is required.

In other words, in order to maintain a 16-bit resolution, a calculation based on Equation 9 requires 32 bits to express p [i][j], while a calculation based on Equation 12 requires only 16 bits to express p [i][j]. In Equation 12, since the result of P[i][j] [symbol] (mean[i][j] [symbol] feature[k][j]) is squared, a similar effect to that obtained from the calculation of Equation 9 using 1/σ² can be obtained.

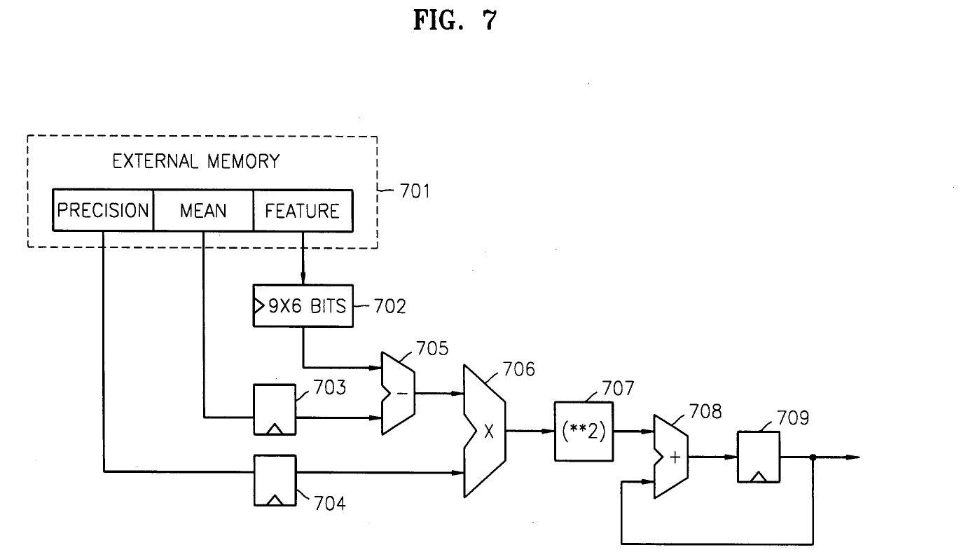

FIG. 7 is a block diagram showing a structure of an observation probability calculation device used in a voice recognition device according to an embodiment of the present invention. The device of FIG. 7 is implemented within the HMM 428 of FIG. 4. As will be described below, the HMM 428 includes the observation probability calculation device of FIG. 7 and a controller (not shown) which decodes a command word to control the observation probability calculation device of FIG. 7.

The observation probability calculation device of FIG. 7 includes a subtractor 705, a multiplier 706, a squarer 707, and an accumulator 708. Reference numerals 702, 703, 704, and 709 denote registers.

An external memory 701, which is a database, stores the precision, mean, and feature of every phoneme sample. Here, precision denotes a distribution degree (1/σ), mean denotes a mean value of the parameters (energy+cepstrum) of each of the phoneme samples, and feature[k][j] denotes the parameters (energy+cepstrum) of a phoneme.

In the observation probability calculation device of FIG. 7, first, the subtractor 705 calculates the difference between a mean and a feature. Then, the multiplier 706 multiplies the calculated difference by a distribution degree (1/σ) to obtain a real distance. Next, the squarer 707 squares the result of the multiplication to obtain an absolute difference. Thereafter, the accumulator 708 accumulates the resultant square into the previous parameter.

That is to say, a result expressed in Equation 12 is obtained by the multiplier 706, and an Σ calculation result expressed in Equation 9 is obtained by the accumulator 708.

The external memory 701 stores p [i][j], mean [i][j], and feature [i][j] and sequentially provides them to the registers 702, 703, and 704 in a predetermined sequence. The predetermined sequence is predetermined so that i and j sequentially increase.

While i and j alternate, p [i][j], mean [i][j], and feature [i][j] are sequentially provided to the registers 702, 703, and 704. The register 709 obtains a final accumulated observation probability. A phoneme sample most probabilistically similar to an input phoneme by such an accumulation of probabilities has the greatest probability. The registers 702, 703, 704, and 709 at the front and rear ends of the observation probability calculation device of FIG. 7 are used to stabilize data.

The multiplier 706 and the accumulator 708 of FIG. 7 can be supported by the MAC unit 408 of FIG. 4.

In the observation probability calculation device of FIG. 7, the bit resolution of data can vary depending on the structure of a processor. As the number of bits increases, a more detailed result can be calculated. However, since the bit resolution relates to the size of a circuit, an appropriate resolution must be selected in consideration of a recognition rate.

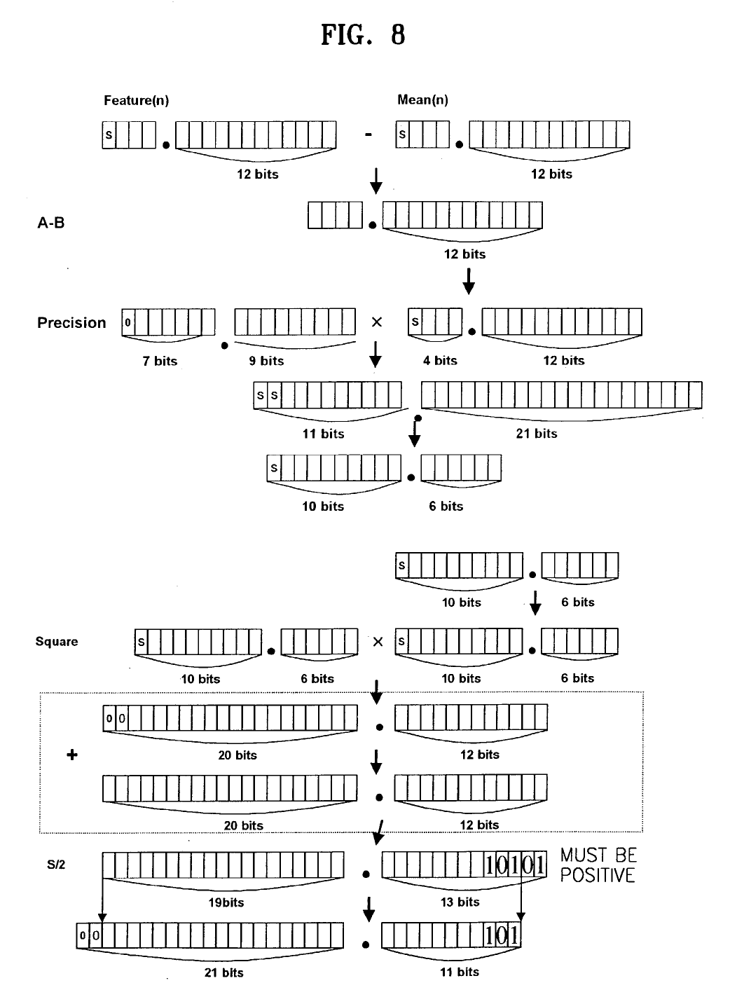

To facilitate an understanding of selection of a bit resolution, FIG. 8 shows an internal bit resolution of a processor with a 16-bit resolution. Here, a cutting process in each step is based on a limit of the data width to 16 bits and corresponds to a selection process for maximally preventing a degradation of the performance. Compared to when only a general-purpose processor, if the observation probability calculation device according to an embodiment of the present invention is used, a great improvement in the processing speed can be achieved.

A feature and a mean are each composed of a 4-bit integer and a 12-bit decimal. The mean is subtracted from the feature in the subtractor 705 to obtain a value composed of a 4-bit integer and a 12-bit decimal.

A precision is composed of a 7-bit integer and a 9-bit decimal. The precision is multiplied by the result of the subtraction in the multiplier 706 to obtain a value composed of a 10-bit integer and a 6-bit decimal.

The resultant value of the multiplier 706 is squared in the squarer 707 to obtain a value composed of a 20-bit integer and a 12-bit decimal. This value is added to the previous value in the accumulator 708 and scaled to obtain a value composed of a 20-bit integer and an 11-bit decimal.

Table 3 shows a comparison between when a voice recognition algorithm using a widely used hidden Markov model is performed in a general processor of ARM series and when the voice recognition algorithm is performed in a dedicated processor adopting the observation probability calculation device according to an embodiment of the present invention.

TABLE 3

| Processor | Number of cycles | Time (20 M CLK) |
|---|---|---|
| ARM processor | 36,400,974 | 1.82 s |
| Processor adopting observation | 15,151,534 | 0.758 s |
| probability calculation device | | |

As can be seen from Table 3, a general-purpose processor performs about 36 million cycles to perform voice recognition, while a dedicated processor adopting a dedicated device for observation probability calculation performs only about 15 million cycles, the number being a half of the number of cycles in the general-purpose processor. Thus, real time voice recognition is possible. In other words, the dedicated processor provides the same performance as that of a general-purpose processor even at a low clock frequency. Hence, power consumption is greatly reduced. By reference, the relationship between the amount of power consumption and a clock frequency can be expressed as in Equation 13:

$$P = \frac{1}{2} \cdot C \cdot f \cdot {V}^{2}$$

wherein P denotes the amount of power consumption, and C denotes a capacitance which is a property of a circuit. In Equation 13, f denotes the degree of a total of transitions of a signal within a circuit. The transitions depend on a clock speed. In Equation 13, V denotes a supplied voltage. Accordingly, if the clock speed is halved, the amount of power consumption is also halved, theoretically.

In the voice recognition device of FIG. 4, the CLKGEN 418 generates a clock signal to be provided to the other constituent modules of the voice recognition device and supports a change of the clock speed to achieve low power consumption.

The observation probability calculation device according to an embodiment of the present invention of FIG. 7 stores mean values of phoneme samples of individual people types pre-obtained in an empirical method, probabilities of transitions between phoneme samples, a degree of distribution, and parameters extracted from a newly input voice in the external memory 701. These data are first stored in the registers 702, 703, and 704 of the dedicated observation probability calculation device to minimize a change in a signal due to a change in external data. The storage of data in the dedicated observation probability calculation device closely relates to power consumption. Among the data stored in the internal registers of the dedicated observation probability calculation device, the difference between the parameter (e.g., feature) extracted from the input voice and the pre-stored mean value is obtained by the subtractor 705.

The resultant difference is multiplied by precision representing the distribution degree (1/σ) in the multiplier 706. The multiplication result is squared in the squarer 707 to obtain a substantial probabilistic distance. Since the substantial probabilistic distance corresponds to only a present parameter among many voice parameter frames that form a word, the substantial probabilistic distance must be added to the previous probabilistic distance in the accumulator 708 to accumulate probabilistic distance values. To achieve accumulation, data stored in the register 709 is provided to the accumulator 708 so that the data is used in the next calculation.

These registers are not only used for the accumulation operation but are also used to minimize a signal transition. The accumulation operation is equally applied to all pre-determined phonemes, and the resultant accumulated values are stored in places for individual phonemes or individual states. Consequently, if the accumulation calculations with respect to all parameters of the input voice are completed, the greatest accumulated value for each of the phonemes of a word can be recognized as the most probabilistically similar phoneme. A determination of the final recognized word using the accumulated values is performed in an existing processor.

The HMM 428 of FIG. 4 corresponds to the dedicated observation probability calculation device of FIG. 7. The HMM 428 performs a word search using hidden Markov models pre-determined from the feature values of an input voice.

In other words, the HMM 428 receives a command via the OPcode buses 0 and 1 (OPcode buses 448 and 450), decodes the command, and controls the dedicated observation probability calculation device of FIG. 7 to perform an observation probability calculation. Data necessary for the observation probability calculation are provided via the two read buses 442 and 444 and are output via the write bus 446.

The HMM 428 receives a control command from the control unit 402 of FIG. 4 via the two OPcode buses 448 and 450, decodes the control command using its internal controller (not shown), and controls the dedicated observation probability calculation device of FIG. 7 to perform an observation probability calculation.

A dedicated observation probability calculation device according to an embodiment of the present invention can efficiently perform an observation probability calculation, which occupies a high percentage of the total calculations, using the above-described hidden Markov model search method.

In addition, the dedicated observation probability calculation device according to an embodiment of the present invention can reduce the number of command words used by 50% or greater. Thus, operations necessary for the observation probability calculation can be performed at a low clock speed, and the amount of power consumption can be halved.

Furthermore, the dedicated observation probability calculation device according to an embodiment of the present invention can be used to perform a probability calculation based on hidden Markov models.

Fast Fourier transform is an algorithm for transforming a signal between the frequency domain and the time domain and is generally implemented in software. However, a recent trend is that the fast Fourier transform is implemented in hardware to achieve fast real time processing.

Recently, a European digital broadcasting standard adopted orthogonal frequency division multiplexing (COFDM) including a Fourier transform to increase immunity against channel noise. Also, various measurers (e.g., spectrum analyzers), voice recognition devices, and the like use a fast Fourier transform device.

A Fourier transform for discrete signals can be achieved using either a discrete Fourier transform or a fast Fourier transform. The discrete Fourier transform deteriorates the efficiency of resources because a N×N number of calculations is required. However, the fast Fourier transform can be efficiently performed since only a (N/2)log(N) number of calculations are required. In particular, as the number of signals increases, the number of calculations geometrically decreases. Thus, the fast Fourier transform is widely used in the field of fast real time processing.

A FFT calculation can be expressed as in Equation 14:

$$\begin{matrix}X ( k ) = {\sum }_{n = 0}^{N - 1} x ( n ) \cdot {ⅇ}^{- j \frac{2 π}{N} k \cdot n} \\ = {\sum }_{n = 0}^{N / 2 - 1} x ( n ) \cdot {ⅇ}^{- j \frac{2 π}{N} k \cdot n} + {\sum }_{n = N / 2}^{N - 1} x ( n ) \cdot {ⅇ}^{- j \frac{2 π}{N} k \cdot n} \\ = {\sum }_{n = 0}^{N / 2 - 1} x ( n ) \cdot {ⅇ}^{- j \frac{2 π}{N} k \cdot n} + \\ {\sum }_{n = 0}^{N / 2 - 1} x ( N / 2 + n ) \cdot {ⅇ}^{- j \frac{2 π}{N} k \cdot n} \cdot {ⅇ}^{- j \frac{2 π}{N / 2} k \cdot n}\end{matrix} \qquad ( 14 )$$

If k is an even number, k can be represented as 2r. If 2r is substituted into k in Equation 14, Equation 14 can be rearranged into Equation 15:

$$\begin{matrix}X ( 2 r ) = {\sum }_{n = 0}^{N / 2 - 1} x ( n ) \cdot {ⅇ}^{- j \frac{2 π}{N} 2 r \cdot n} + \\ {\sum }_{n = 0}^{N / 2 - 1} x ( N / 2 + n ) \cdot {ⅇ}^{- j \frac{2 π}{N} 2 r \cdot n} \cdot {ⅇ}^{- j \frac{2 π}{N / 2} 2 r \cdot n} \\ = {\sum }_{n = 0}^{N / 2 - 1} x ( n ) \cdot {ⅇ}^{- j \frac{2 π}{N} 2 r \cdot n} + {\sum }_{n = 0}^{N / 2 - 1} x ( N / 2 + n ) \cdot {ⅇ}^{- j \frac{2 π}{N} 2 r \cdot n} \\ = {\sum }_{n = 0}^{N / 2 - 1} \{ x ( n ) + x ( N / 2 + n ) \} \cdot {ⅇ}^{- j \frac{2 π}{N} 2 r \cdot n} \\ = {\sum }_{n = 0}^{N / 2 - 1} \{ x ( n ) + x ( N / 2 + n ) \} \cdot {ⅇ}^{- j \frac{2 π}{N} r \cdot n}\end{matrix} \qquad ( 15 )$$

If k is an odd number, k can be represented as 2r+1. If 2r+1 is substituted into k in Equation 14, Equation 14 can be rearranged into Equation 16:

$$\begin{matrix}X ( 2 r + 1 ) = {\sum }_{n = 0}^{N / 2 - 1} x ( n ) \cdot {ⅇ}^{- j \frac{2 π}{N} ( 2 r + 1 ) \cdot n} + \\ {\sum }_{n = 0}^{N / 2 - 1} x ( N / 2 + n ) \cdot {ⅇ}^{- j \frac{2 π}{N} ( 2 r + 1 ) \cdot n} \cdot {ⅇ}^{- j \frac{2 π}{N / 2} ( 2 r + 1 ) \cdot n} \\ = {\sum }_{n = 0}^{N / 2 - 1} x ( n ) \cdot {ⅇ}^{- j \frac{2 π}{N} ( 2 r + 1 ) \cdot n} - \\ {\sum }_{n = 0}^{N / 2 - 1} x ( N / 2 + n ) \cdot {ⅇ}^{- j \frac{2 π}{N} ( 2 r + 1 ) \cdot n} \\ = {\sum }_{n = 0}^{N / 2 - 1} \{ x ( n ) - x ( N / 2 + n ) \} \cdot {ⅇ}^{- j \frac{2 π}{N} 2 r \cdot n} \cdot {ⅇ}^{- j \frac{2 π}{N} \cdot n} \\ = {\sum }_{n = 0}^{N / 2 - 1} \{ x ( n ) - x ( N / 2 + n ) \} \cdot {ⅇ}^{- j \frac{2 π}{N / 2} r \cdot n} \cdot {ⅇ}^{- j \frac{2 π}{N} \cdot n}\end{matrix} \qquad ( 16 )$$

Accordingly, X(k) can be rearranged as in Equation 17:

$$\begin{matrix}X ( k ) = X ( 2 r ) + X ( 2 r + 1 ) \\ = {\sum }_{n = 0}^{N / 2 - 1} \{ x ( n ) + x ( N / 2 + n ) \} \cdot {ⅇ}^{- j \frac{2 π}{N / 2} r \cdot n} + \\ {\sum }_{n = 0}^{N / 2 - 1} \{ x ( n ) - x ( N / 2 + n ) \} \cdot {ⅇ}^{- j \frac{2 π}{N / 2} r \cdot n} \cdot {ⅇ}^{- j \frac{2 π}{N} \cdot n}\end{matrix} \qquad ( 17 )$$

Equation 17 shows that a discrete Fourier transform (DFT) on N points (e.g., N sampled data) can be divided into two DFTs on N/2 points, the division is repeated to obtain a DFT having a basic structure, and the basic DFT is repetitively performed to achieve an FFT.

In Equation 17,

$${ⅇ}^{- j \frac{2 π}{N / 2} r \cdot n}$$

can be excluded since it is calculated in the next FFT calculation.

If the conventional Euler formula is applied to

$${ⅇ}^{- j \frac{2 π}{N} \cdot n} , {ⅇ}^{- j \frac{2 π}{N} \cdot n}$$

can be expressed as in Equation 18:

$${ⅇ}^{- j \frac{2 π}{N} n} = cos ( \frac{2 π}{N} n ) - j sin ( \frac{2 π}{N} n ) \qquad ( 18 )$$

Accordingly, Equation 17 can be rearranged into Equation 19:

$$x ( n ) = \{ \{ x ( n ) - x ( \frac{N}{2} + n ) \} cos \frac{2 π}{N} + j \{ x ( n ) - x ( \frac{N}{2} + n ) \} sin \frac{2 π}{N} \} \qquad ( 19 )$$

By substituting z(n) for x(n) of Equation 19, a complex FFT on a signal z(n)=x(n)+jy(n) having a complex value is obtained as in Equation 20:

$$z ( n ) = \{ \{ z ( n ) - z ( \frac{N}{2} + n ) \} cos \frac{2 π}{N} + j \{ z ( n ) - z ( \frac{N}{2} + n ) \} sin \frac{2 π}{N} \} \qquad ( 20 )$$

By substituting x(n)+jy(n) for z(n) of Equation 20, Equation 20 can be rearranged into Equation 21:

$$\begin{matrix}z ( n ) = \{ \{ x ( n ) - x ( \frac{N}{2} + n ) \} cos \frac{2 π}{N} - \{ y ( n ) - y ( \frac{N}{2} + n ) \} sin \frac{2 π}{N} \} + \\ j \{ \{ y ( n ) - y ( \frac{N}{2} + n ) \} cos \frac{2 π}{N} - \{ x ( n ) - x ( \frac{N}{2} + n ) \} sin \frac{2 π}{N} \}\end{matrix} \qquad ( 21 )$$

wherein x(n) is a real number, y(n) is an imaginary number,

$$\{ \{ x ( n ) - x ( \frac{N}{2} + n ) \} cos \frac{2 π}{N} - \{ y ( n ) - y ( \frac{N}{2} + n ) \} sin \frac{2 π}{N} \}$$

denotes the real number part of an output value obtained by a complex FFT, and

$$j \{ \{ y ( n ) - y ( \frac{N}{2} + n ) \} cos \frac{2 π}{N} - \{ x ( n ) - x ( \frac{N}{2} + n ) \} sin \frac{2 π}{N} \}$$

denotes the imaginary number part of the output value obtained by the complex FFT.

A real number FFT is performed by substituting a current data block into the real number part of a complex FFT and substituting 0 into the imaginary number part of the complex FFT. Thus, the imaginary number FFT is unnecessary. To prevent the unnecessary FFT calculation, a next data block instead of 0 is substituted for the imaginary number part of the complex FFT. Consequently, two FFT results are obtained at one time. This complex FFT calculation results in a different value than when data blocks are individually FFT calculated. However, if two data blocks are not significantly different from each other like a voice signal, FFT can be performed within a small error range. For example, if consecutive data blocks on a time axis are indicated by D(T), D(T−1), D(T−2), . . . , an FFT on D(T) is calculated by substituting D(T) and D(T−1) for the real number part and the imaginary number part, respectively, of the first FFT. An FFT on D(T−1) is calculated by substituting D(T−1) and D(T−2) for the real number part and the imaginary number part, respectively, of the second FFT. This duplicate FFT calculation on individual data blocks can further narrow the error range.

That is to say, in an FFT calculation on a first complex number composed of a first real number and a first imaginary number and a second complex number composed of a second real number and a second imaginary number, the first and second real numbers corresponding to x(n) and

$$x ( \frac{N}{2} ) ,$$

respectively, are blocked in a real number data block. The first and second real numbers corresponding to y(n) and

$$y ( \frac{N}{2} ) ,$$

respectively, are blocked in an imaginary number data block.

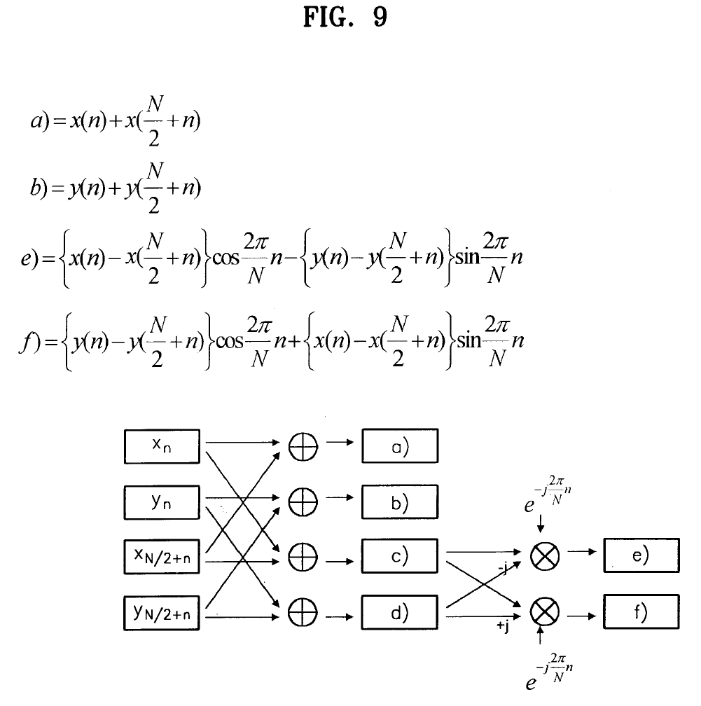

FIG. 9 shows a fundamental structure of a device for performing a complex FFT of a radix 2. The device of FIG. 9 is typically well known as a butterfly calculator.

In FIG. 9, arrows indicate the flow of data, +/× in circles denotes an addition/multiplication, and contents in rectangles denote inputs or calculation results (e.g., outputs). The contents in the left rectangles denote inputs, the contents in the right rectangles denote outputs, and the contents in the rectangles in the middle denote intermediate values necessary to obtain the outputs.

xₙ and

$${x}_{\frac{N}{2} + n}$$

are real number inputs, and yₙ and

$${y}_{\frac{N}{2} + n}$$

are imaginary number inputs. In fact, xₙ and

$${x}_{\frac{N}{2} + n}$$

are n-th and (n/2+n)th data, respectively, of the data block D(T−1), and yₙ and

$${y}_{\frac{N}{2} + n}$$

are n-th and (n/2+n)th data, respectively, of the data block D(T−2). If two consecutive data blocks D(T−1) and D(T−2) are sampled from a signal not sharply fluctuating, e.g., a voice signal, a complex FFT can be performed within a narrow error range.

An intermediate value a) is

$$x ( n ) + x ( \frac{N}{2} + n ) .$$

An intermediate value b) is

$$y ( n ) + y ( \frac{N}{2} + n ) .$$

An intermediate value c) is

$$x ( n ) - x ( \frac{N}{2} + n ) .$$

An intermediate value d) is

$$y ( n ) - y ( \frac{N}{2} + n ) .$$

An output value e) is

$$\{ \{ x ( n ) - x ( \frac{N}{2} + n ) \} cos \frac{2 π}{N} - \{ y ( n ) - y ( \frac{N}{2} + n ) \} sin \frac{2 π}{N} \} .$$

An output value f) is

$$\{ \{ y ( n ) - yx ( \frac{N}{2} + n ) \} cos \frac{2 π}{N} + \{ x ( n ) - x ( \frac{N}{2} + n ) \} sin \frac{2 π}{N} \} .$$

The output values e) and f) are used in the DFT at the next stage but actually return to the basic structure shown in FIG. 9.

As shown in values e) and f), a complex FFT on a radix 2, which is a basic FFT calculation implementation, results in four values by inputting four terms and two coefficients.

Such an FFT calculation can be roughly classified into software using a general-purpose processor and software using a dedicated FFT calculation device. General processors, such as a central processing unit (CPU) or a digital signal processor (DSP), typically use the 3-bus system. In the 3-bus system, calculations that obtain one result value by calculating two terms, such as, an addition or a multiplication, can be performed at one cycle using a pipelining method. However, a calculation that obtains four result values by inputting four terms and two coefficients (e.g., sine and cosine coefficients), such as, a complex FFT on a radix 2, which is a basic FFT calculation, requires many cycles. Thus, in the 3-bus system, even if operations necessary for such a calculation are performed in a pipeline fashion, the calculation cannot be performed fast.

To solve this problem, a conventional FFT calculation device adopts a memory dedicated for coefficients, an address computer, and a dedicated bus. Alternatively, a conventional FFT calculation device adopts two write buses. However, these two cases are disadvantageous in terms of the chip size, power consumption, or the like. Also, production yield may be degraded due to the unusual structure of a conventional FFT calculation device. Furthermore, since a conventional FFT calculation device lacks of compatibility with general-purpose processors, it cannot be immediately utilized in the IP industry.

The embodiments of the present invention provides an improved complex FFT calculation device which can maximize the speed of an FFT calculation.

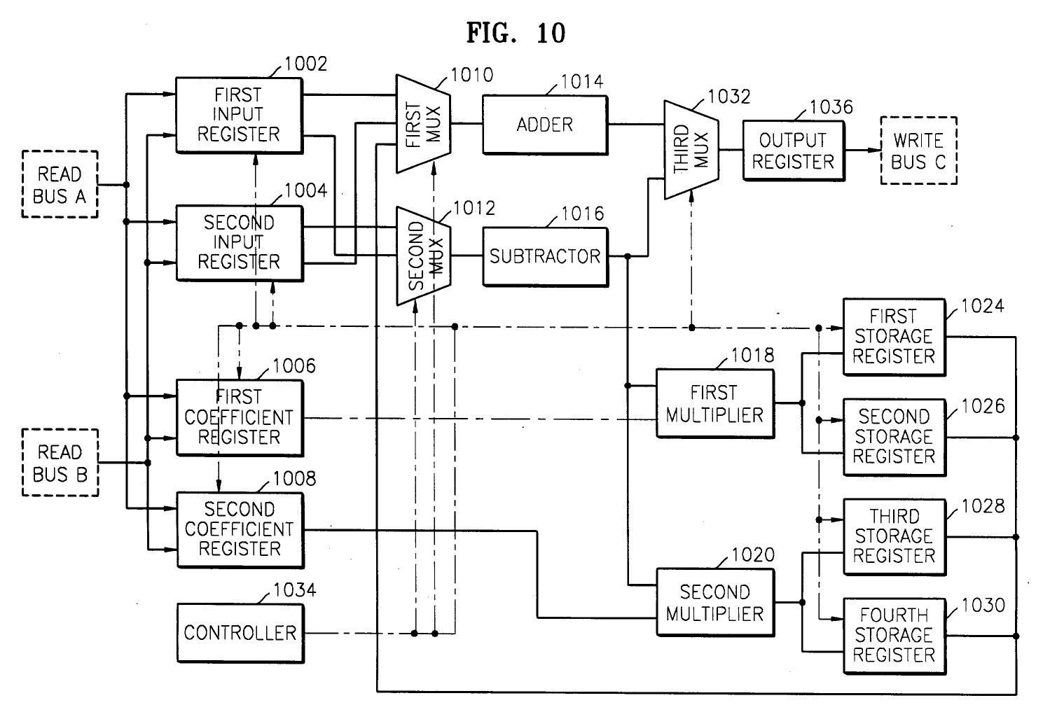

FIG. 10 is a block diagram showing a structure of a complex FFT calculation device used in a voice recognition device according to an embodiment of the present invention. The complex FFT calculation device of FIG. 10 is used in a 3-bus system, which has two read buses and one write bus, and implemented in the FFT unit 412 of FIG. 4.

The complex FFT calculation device of FIG. 10 includes first and second input registers 1002 and 1004 for loading data necessary for a complex FFT calculation from read buses A and B (read buses 442 and 444), first and second coefficient registers 1006 and 1008 for loading sine and cosine values necessary for the complex FFT calculation from the read buses A and B (read buses 442 and 444), an adder 1014, a subtractor 1016, first and second multipliers 1018 and 1020 for multiplying an output of the subtractor 1016 by each of the outputs of the coefficient registers 1006 and 1008, four storage registers 1024, 1026, 1028, and 1030 used when the complex FFT calculation is performed, first and second multiplexers 1010 and 1012 for supporting the operations of the adder 1014 and the subtractor 1016, a third multiplexer 1032 for controlling an output operation, and a controller 1034 for controlling the operations of the constituent members of the complex FFT calculation device of FIG. 10.

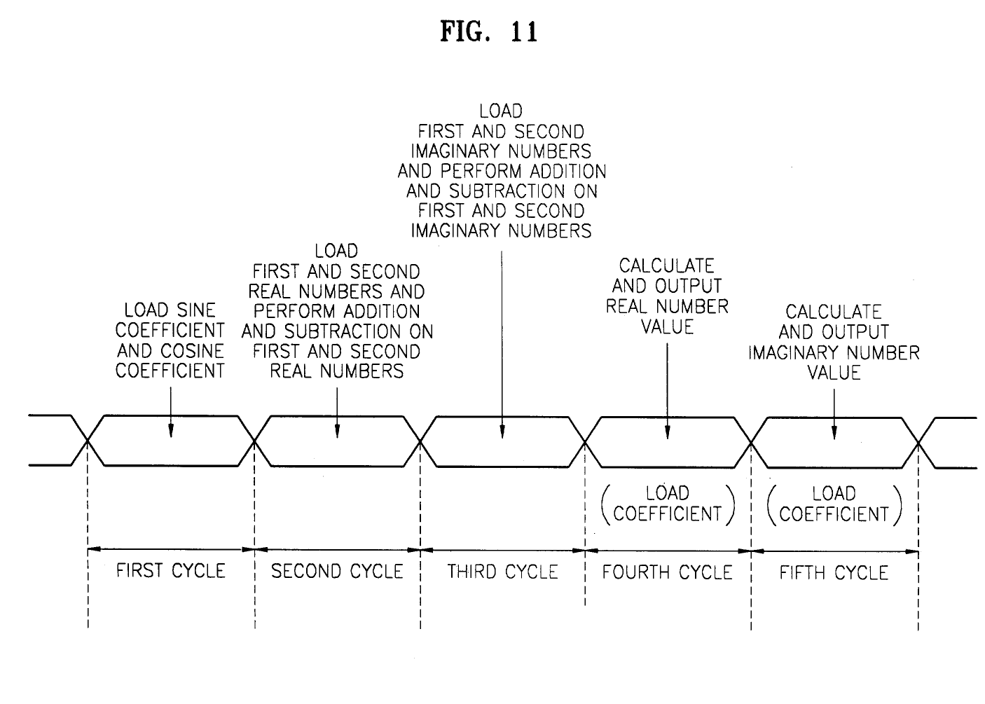

FIG. 11 is a timing diagram for illustrating the operation of the complex FFT calculation device of FIG. 10. A complex FFT calculation on a radix of 2 in the complex FFT calculation device of FIG. 10 is performed during fourth and fifth cycles.

In a first cycle, a sine coefficient and a cosine coefficient to be used during a complex FFT calculation are loaded in the first and second coefficient registers 1006 and 1008, respectively, via the read buses A and B, respectively.

In a second cycle, real number data to be used for a complex FFT calculation are loaded and then subjected to an addition and a subtraction. To be more specific, xₙ is loaded in the first input register 1002 via the read bus A, and

$${x}_{\frac{N}{2} + n}$$

is loaded in the second input register 1004 via the read bus B. The adder 1014 adds xₙ to

$${x}_{\frac{N}{2} + n} ,$$

and the subtractor 1016 subtracts

$${x}_{\frac{N}{2} + n}$$

from xₙ. Since the adder 1014 and the subtractor 1016 automatically perform their operations when receiving inputs, extra operational cycles are not required. The output of the adder 1014 is provided to the third multiplexer 1032, and the output of the subtractor 1016 is provided to the third multiplexer 1032 and the first and second multipliers 1018 and 1020.

The first multiplier 1018 multiplies the output of the subtractor 1016,

$${x}_{n} - {x}_{\frac{N}{2} + n} ,$$

by the sine coefficient loaded in the first coefficient register 1006 to obtain the second term of the formula expressing the value f) of FIG. 9,

$$\{ x ( n ) - x ( \frac{N}{2} + n ) \} sin \frac{2 π}{N} .$$

The output of the first multiplier 1018 is stored in the first storage register 1024.

The second multiplier 1020 multiplies the output of the subtractor 1016,

$${x}_{n} - {x}_{\frac{N}{2} + n} ,$$

by the cosine coefficient loaded in the second coefficient register 1008 to obtain the first term of the formula in which the value e) of FIG. 9 is expressed,

$$\{ x ( n ) - x ( \frac{N}{2} + n ) \} cos \frac{2 π}{N} .$$

The output of the second multiplier 1020 is stored in the second storage register 1026.

In a third cycle, imaginary number data to be used upon a complex FFT calculation are loaded and then subjected to an addition and a subtraction. To be more specific, yₙ is loaded in the first input register 1002 via the read bus A, and

$${y}_{\frac{N}{2} + n}$$

is loaded in the second register 1004 via the read bus B. The adder 1014 adds yₙ to

$${y}_{\frac{N}{2} + n} ,$$

and the subtractor 1016 subtracts

$${y}_{\frac{N}{2} + n}$$

from yₙ. Since the adder 1014 and the subtractor 1016 automatically perform their operations when receiving inputs, extra operational cycles are not required. The output of the adder 1014 is provided to the third multiplexer 1032, and the output of the subtractor 1016 is provided to the third multiplexer 1032 and the first and second multipliers 1018 and 1020.

The first multiplier 1018 multiplies the output of the subtractor 1016,

$${y}_{n} - {y}_{\frac{N}{2} + n} ,$$

by the sine coefficient loaded in the first coefficient register 1006 to obtain the second term of the formula in which the value e) of FIG. 9 is expressed,

$$\{ y ( n ) - y ( \frac{N}{2} + n ) \} sin \frac{2 π}{N} .$$

The output of the first multiplier 1018 is stored in the third storage register 1028.

The second multiplier 1020 multiplies the output of the subtractor 1016,

$${y}_{n} - {y}_{\frac{N}{2} + n} ,$$

by the cosine coefficient loaded in the second coefficient register 1008 to obtain the first term of the formula in which the value f) of FIG. 9 is expressed,

$$\{ y ( n ) - y ( \frac{N}{2} + n ) \} cos \frac{2 π}{N} .$$

The output of the second multiplier 1026 is stored in the fourth storage register 1030.

In a fourth cycle, the real number value of a complex FFT of a radix 2 (e.g., the value e) of FIG. 9) is calculated using the values stored in the second and third storage registers 1026 and 1028.

To be more specific,

$$\{ x ( n ) - x ( \frac{N}{2} + n ) \} cos \frac{2 π}{N}$$

stored in the second storage register 1026 and

$$\{ y ( n ) - y ( \frac{N}{2} + n ) \} sin \frac{2 π}{N}$$

stored in the third storage register 1028 are provided to the subtractor 1016 via the second multiplexer 1012. The subtractor 1016 subtracts

$$\{ y ( n ) - y ( \frac{N}{2} + n ) \} sin \frac{2 π}{N}$$

from

$$\{ x ( n ) - x ( \frac{N}{2} + n ) \} cos \frac{2 π}{N}$$

and provides the difference between them to the third multiplexer 1032. It can be noted that the output of the subtractor 1016 is the value e) of FIG. 9, e.g., the real number part of the complex FFT calculation on a radix of 2.

The output of the subtractor 1016 is provided to an output register 1036 via the third multiplexer 1032 and stored in a memory (not shown) via a write bus C.

In a fifth cycle, the imaginary number value of a complex FFT of a radix 2 (e.g., the value f) of FIG. 9) is calculated using the values stored in the first and fourth storage registers 1024 and 1030.

To be more specific,

$$\{ x ( n ) - x ( \frac{N}{2} + n ) \} sin \frac{2 π}{N}$$

stored in the first storage register 1024 and

$$\{ y ( n ) - y ( \frac{N}{2} + n ) \} cos \frac{2 π}{N}$$

stored in the fourth storage register 1030 are provided to the adder 1014 via the first multiplexer 1010. The adder 1014 adds

$$\{ y ( n ) - y ( \frac{N}{2} + n ) \} cos \frac{2 π}{N} to \{ x ( n ) - x ( \frac{N}{2} + n ) \} sin \frac{2 π}{N}$$

and provides the sum between them to the third multiplexer 1032. It can be noted that the output of the adder 1014 is the value f) of FIG. 9, that is, the imaginary number part of the complex FFT calculation on a radix of 2.

The output of the adder 1014 is provided to the output register 1036 via the third multiplexer 1032 and stored in the memory (not shown) via the write bus C.

To compute a complex FFT on N points using a butterfly calculation device for a radix 2 as shown in FIG. 10, a (N/2)log(N) number of stages must be performed. Here, N denotes a power of 2, and the point is a unit representing the number of data existing in a data block.

In the case of a complex FFT calculation on 16 points, four stages are required. In the case of a complex FFT calculation on 256 points, eight stages are required.

FIG. 11 shows a flow of data in individual stages in the case of a complex FFT calculation on 16 points. After the complex FFT calculation is completed, finally obtained FFT coefficients are output in a sequence different from the input sequence of data points in the first stage. Thus, the FFT coefficients need to be rearranged, but this will not be described in detail.

Hereinafter, the number of cycles required for the radix-2 butterfly calculation device of FIG. 10 to achieve a complex FFT calculation on 256 points will be calculated.

In each stage of a complex FFT calculation on an N-point data block, a DFT on a data block of m points (m denotes a positive even number and is equal to or less than N) at the previous stage is transformed into two DFTs on m/2-point data blocks. Accordingly, each stage requires N/2 radix-2 complex FFT calculations. Hence, in the case of a complex FFT on 256 points, the same operation is repeated 128 times while changing a data point in each stage using the device of FIG. 10.

The number of cycles required for a complex FFT calculation is 5,120, which is obtained by calculating the following formula:

$$The number of cycles = ( 1 cycle for loading coefficients + 4 cycles for calculation and outputting ) \times 128 ( which is the number of times of repetition of an FFT at one stage ) \times 8 ( which is the number of stages for an FFT of 256 points )$$

This calculation is based on a block-fixed algorithm for calculating a complex FFT of blocks, wherein the number of blocks doubles in each stage.

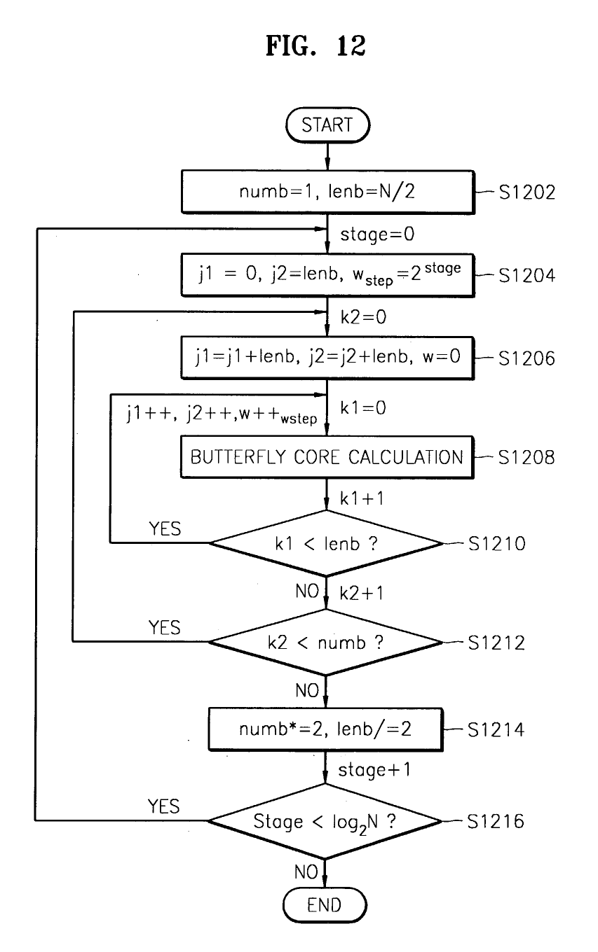

FIG. 12 is a flowchart illustrating a block-fixed algorithm. In an FFT calculation, the number of blocks at a current stage is twice the number of blocks at the previous stage, but all blocks in a stage share coefficients. For example, the number of blocks increases twice every stage, e.g., from N/2 at a current stage to N/2*2 at the next stage, but the size of each block is halved every stage.

In a block-fixed algorithm, independent operations are performed for individual blocks. To be more specific, every time an FFT of a data block is calculated, necessary coefficients are loaded.

In step S1202, variables for a first stage (stage 0) are set. Variable numb (which denotes the number of blocks) is set to be 1, and variable lenb (which denotes the length of a block) is set to be N/2.

In step S1204, the initial value of variable j1 for addressing real number data is set to be 0, and the initial value of variable j2 for addressing imaginary number data are set to be the value of variable lenb. It is assumed that the real number data, e.g., a data block D(T−1), and the imaginary number data, e.g., a data block D(T−1), are consecutively stored in a memory. Variable wₛₜₑₚ denotes the basis of variable w.

In step S1206, the initial value of variable j1 for each data block is set to be a sum of the initial value of variable j1 set in step S1204 and the initial value of variable lenb. The initial value of variable j2 for each data block is set to be a sum of the initial value of variable j2 set in step S1204 and the initial value of variable lenb. Variable w is set to be 0. Variable k2 represents a data block to be processed.

In step S1208, a butterfly calculation is performed. An FFT of individual data blocks is calculated using the device of FIG. 10. Variable k1 represents the sequence of data processed.

In step S1210, next data to be processed is designated. Variable k1 is updated by 1, and the updated value of variable k1 is compared with the value of variable lenb. If the value of variable k1 is smaller than the value of variable lenb, e.g., if data to be processed remains in a current data block, the method goes back to step S1208. On the other hand, if the value of variable k1 is equal to or greater than the value of variable lenb, e.g., if all data in the current data block have been completely processed, the method proceeds to step S1212.

In step S1212, a next data block to be processed is designated. The value of variable k2 is updated by 1, and an updated value of variable k2 is compared with the value of variable numb. If the value of variable k2 is smaller than the value of variable numb, e.g., if a block to be processed remains in a current stage, the method goes back to step S1206. On the other hand, if the value of variable k2 is equal to or greater than the value of variable numb, e.g., if all data blocks for the current stage have been completely processed, the method proceeds to step S1214.

In step S1214, a next stage to be performed is designated. The value of variable numb is doubled, and the value of variable lenb is halved.

In step S1216, it is determined whether all stages have been completely performed. The value of variable stage is updated by 1, and the updated value of variable stage is compared with log₂N. If the updated value of variable stage is smaller than log₂N, the method goes back to step S1204. On the other hand, if the updated value of variable stage is equal to or greater than log₂N, the current FFT calculation is concluded.

In a block-fixed algorithm, a cycle for loading coefficients is required for each data point, but an operation for addressing data points in each block is simplified because a next data point can be addressed through a simple increment operation. Accordingly, a block-fixed algorithm is suitable for front stages in which a small number of blocks are processed.

In a block-fixed algorithm, a coefficient is loaded every time an FFT of a data block is calculated. A coefficient-fixed algorithm, in which operations that use coefficients common to each data block are extracted and performed after the common coefficients are loaded, can also be adopted.

The maximum number of cycles required for an FFT is 4,351, which is obtained by calculating

$${\sum }_{stage = 1}^{8} \frac{1 * 128}{{2}^{stage - 1}} + 4 * 128 * 8.$$

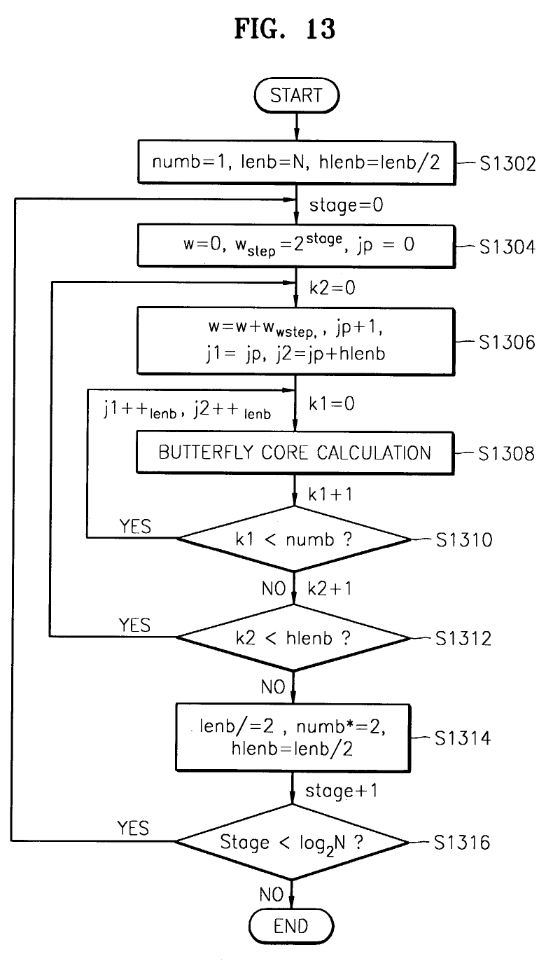

FIG. 13 is a flowchart illustrating a coefficient-fixed algorithm. In a coefficient-fixed algorithm, operations that use coefficients common to each data block are extracted and grouped, the common coefficients are loaded, and the grouped extracted operations are performed at the same time.

In an FFT calculation, the number of data blocks processed in the next stage is twice the number of data blocks processed in the current stage, but the number of data points for each block is halved. However, all blocks processed in a stage use common coefficients. If an FFT of a 256-point data block is calculated, the number of data blocks processed at stage 0 is 2, the number of data points existing in each data block is 128, and the number of coefficients used in each data block is 1428, the coefficients are shared by the data blocks and determined to be 2π n/N (n is 0, 2, 4, . . . , 256, the number of which is 128). That is, if the data points of each data block are ordered, the data points of the data blocks that are on the same order use common coefficients.

In a coefficient-fixed algorithm, coefficients are first loaded, and FFTs of data points that share coefficients among the data blocks are calculated in the sequence of data blocks.

In step S1302, variables for a first stage (stage 0) are set. Variable numb (which denotes the number of blocks) is set to be 1, and variables lenb and hlenb, which denote the length of a block, are set to be N and lenb/2, respectively.

In step S1304, variables w and wₛₜₑₚ for coefficient addressing are set to be 0 and 2^{stage}, respectively, and variable jp for data addressing is set to be 0. Variable stage represents a processed stage, and variable wₛₜₑₚ denotes the basis of variable w.

In step S1306, variable w is increased by variable wₛₜₑₚ, variable jp is increased by 1, and variables j1 and j2 for data addressing are set to be the value of variable jp and a value jp+hlenb, respectively. Here, variable j1 is used to address real number data, and variable j2 is used to address imaginary number data. Variable k1 represents the sequence of data processed.

In step S1308, a butterfly calculation is performed. An FFT of individual stages and an FFT of individual data blocks are calculated using the device of FIG. 10.

In step S1310, next data to be processed is designated. Variable k1 is updated by 1, and the updated value of variable k1 is compared with the value of variable numb. If the value of variable k1 is smaller than the value of variable numb, e.g., if data to be processed remains in a current data block, the method goes back to step S1308. On the other hand, if the value of variable k1 is equal to or greater than the value of variable numb, e.g., if all data in the current data block have been completely processed, the method proceeds to step S1312.

In step S1312, a next data block to be processed is designated. The value of variable k2 is updated by 1, and the updated value of variable k2 is compared with the value of variable hlenb. If the value of variable k2 is smaller than the value of variable hlenb, e.g., if a data block to be processed remains in a current stage, the method goes back to step S1306. On the other hand, if the value of variable k2 is equal to or greater than the value of variable hlenb, e.g., if all data blocks for the current stage have been completely processed, the method proceeds to step S1314. Variable k2 represents a block to be processed.

In step S1314, variables for a next stage to be performed are re-set. The value of variable numb is doubled, and the values of variables lenb and hlenb are halved.

In step S1316, it is determined whether all stages have been completely performed. The value of variable stage is updated by 1, and the updated value of variable stage is compared with log₂N. If the updated value of variable stage is smaller than log₂N, the method goes back to step S1304. On the other hand, if the updated value of variable stage is equal to or greater than log₂N, the current FFT calculation is concluded.

In a coefficient-fixed algorithm, the number of cycles for loading coefficients is halved, but the number of operations of addressing data points that share coefficients among the data blocks increases. Hence, a coefficient-fixed algorithm is more suitable for front stages in which a small number of data blocks are processed than for rear stages in which a large number of data blocks are processed.

According to an analysis, a block-fixed algorithm requires about 6,200 cycles.

A method of separating stages can be further used in a block-fixed algorithm. If stage 7 is separated, about 5,500 cycles are required. If stage 7 is separated from stage 6, about 5,200 cycles are required.

Here, a separation of stages means that a loop (which denotes a recurrent repetition logic, such as, a for-while operation or a do-while operation) is performed with respect to only some stages. To be more specific, if stage 7 is separated, algorithms with respect to stages 0 to 6 are performed within a loop while an algorithm with respect to stage 7 is performed outside a loop.

It is also found that a coefficient-fixed algorithm requires about 5,400 cycles. The method of separating stages can also be used in a coefficient-fixed algorithm. If stage 0 is separated from the other stages, about 5,430 cycles are required. If stage 0 is separated from stage 1, about 5,420 cycles are required. The number of required cycles is not significantly reduced as in the case of a block-fixed algorithm, but is still reduced.

If the two algorithms are combined, e.g., the coefficient-fixed algorithm is used for first through fourth stages and the block fixed algorithm is used for the following stages, the number of required cycles can be reduced to about 4,800 cycles.

Also, if it is considered that coefficients for a next calculation can be input at a fourth or fifth cycle among the above-mentioned cycles, the number of cycles required for a complex FFT calculation can be further reduced to about 4,500 cycles.

In the device of FIG. 10, the adder 1014 and the subtractor 1016 can be commonly used in a calculation for a real number part and a calculation for an imaginary number part. Since the operations of the adder and subtractor do not affect the number of cycles required for an FFT calculation, an extra adder and an extra subtractor for calculating the values e) and f) of FIG. 9 are not installed but the storage registers 1024, 1026, 1028, and 1030, the first and second multiplexers 1010 and 1012, the adder 1014, and the subtractor 1016 are used.

Although a multiplier occupies a wide area on a chip, two multipliers are used to achieve a simultaneous execution, which provides a great advantage.

The controller 1034 receives a command from the control unit 402 via the read bus A or B or a dedicated command bus, decodes the command, and controls operators (the adder 1014, the subtractor 1016, and the first and second multipliers 1018 and 1012), the input/coefficient/storage registers 1002, 1004, 1006, 1008, 1024, 1026, 1028, and 1030, and the first through third multiplexers 1010, 1012, and 1032 to perform an FFT. An inverse FFT (IFFT) is achieved when the sign of an exponential part of Equation 17 is changed to an inverse sign. That is, the FFT is achieved by changing a value input to the adder 1014 and the subtractor 1016 via the storage registers 1024, 1026, 1028, and 1030 and the first and second multiplexers 1010 and 1012.

Since the output register 1036 may overflow, it must be able to output a value whose individual bits are moved to lower positions by the controller 1034, e.g., to achieve ½ scaling.

The FFT unit 412 of FIG. 4 adopts the complex FFT calculation device according to an embodiment of the present invention of FIG. 10. In the complex FFT calculation of FIG. 10, the controller 1034 receives a command via a dedicated command bus (OPcode buses 0 and 1), decodes the received command, and controls operators (the adder 1014, the subtractor 1016, and the first and second multipliers 1018 and 1020), the input/coefficient/storage registers 1002 & 1004/1006 & 1008/1024, 1026, 1028, & 1030, and the first through third multiplexers 1010, 1012, and 1032 to perform an FFT. Necessary data is provided via the two read buses 442 and 444 of FIG. 4 and output via the single write bus 446 of FIG. 4.

The FFT unit 412 receives a control command via the two OPcode buses 448 and 450 from the control unit 402 of FIG. 4. The controller 1034 of FIG. 10 decodes the received control command and controls operators (an adder, a subtractor, and a multiplier), input/coefficient/storage registers, and multiplexers to perform an FFT.

For example, in the FFT calculation device of FIG. 10, the controller 1034 decodes a received control command, controls operators (an adder, a subtractor, and a multiplier), input/coefficient/storage registers, and multiplexers to perform an FFT, and outputs a resultant value to the outside via the output register 1036.

An FFT calculation requires the following 6 control commands.

Firstly, a command A2FFT represents an input of coefficients (cosine and sine) and corresponds to the first cycle.

Secondly, a command FFT Front Real (FFTFR) represents an input, calculation, and output of real number data and corresponds to the second cycle.

Thirdly, a command FFT Front Imaginary (FFTFI) represents an input, calculation, and output of imaginary number data and corresponds to the third cycle.

Fourthly, a command FFT Secondary Real (FFTSR) represents a calculation and output of a real number value and corresponds to the fourth cycle.

Fifthly, a command FFT Secondary Imaginary (FFTSI) represents a calculation and output of an imaginary number value and corresponds to the fifth cycle.

Sixthly, a command FFTSIC represents an input of coefficients during the calculation and output of the real/imaginary number value. To be more specific, the command FFTSIC represents that coefficients for a next calculation are loaded in the coefficient registers 1006 and 1008 during the fourth or fifth cycle. The command FFTSIC is useful in reducing the number of cycles required for a calculation.

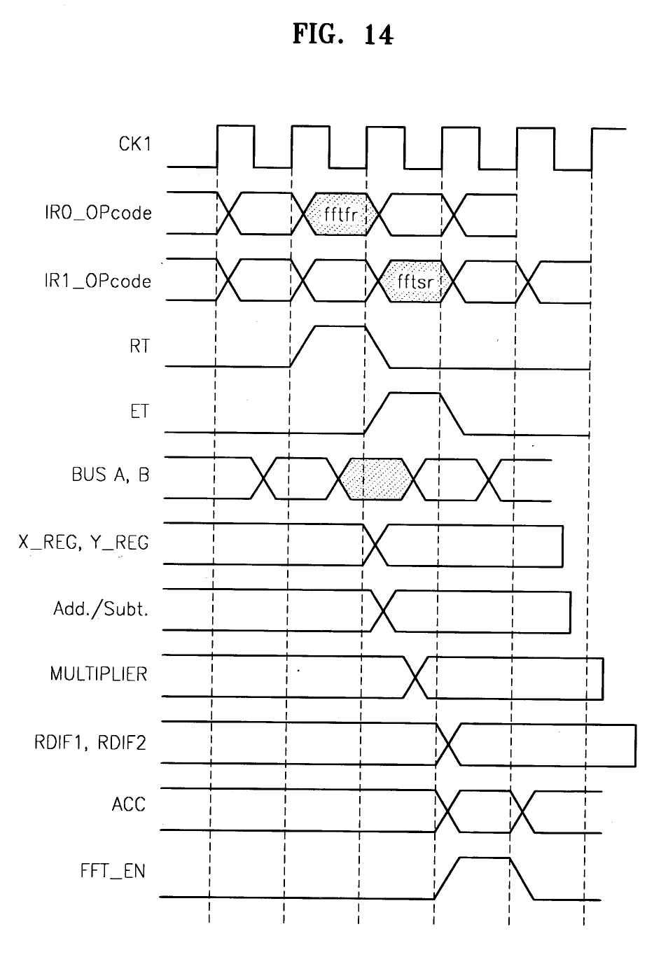

FIG. 14 is a timing diagram for illustrating execution of the command FFTFR. In FIG. 14, the top signal is a clock signal CK1, sequentially followed by a control command applied to the OPcode bus 0, a control command applied to the OPcode bus 1, a signal RT, a signal ET, data applied to the read buses A and B, data applied to the input registers 1002 and 1004, data applied to the adder 1014 and the subtractor 1016, data applied to the multipliers 1018 and 1020, data applied to the first and second storage registers 1024 and 1026, data applied to the output register 1036, and an output enable signal FFT_EN.

When a control command is applied to the OPcode bus 0 and the controller 1034 is enabled by a signal RT, the controller 1034 decodes the control command and enters into a stand-by status for an FFT calculation. Thereafter, if a command FFTSR is applied to the OPcode bus 1 and the controller 1034 is enabled by a signal ET, the controller 1034 performs a control operation to achieve the second cycle.

To be more specific, the controller 1034 controls the input registers 1002 and 1004 to store data received via the read buses A and B. Real number data stored in the input registers 1002 and 1004 are provided to the adder 1014 and the subtractor 1016. The controller 1034 controls the adder 1014 and the subtractor 1016 to operate an addition and a subtraction. The operation result of the subtractor 1016 is provided to the multipliers 1018 and 1020. The controller 1034 controls the multipliers 1018 and 1020 to operate a multiplication, the storage registers 1024 and 1026 to store the operation results of the multipliers 1018 and 1020, and the third multiplexer 1032 to store the operation result of the subtractor 1016 in the output register 1036.

Next, the controller 1034 outputs the output enable signal FFT_EN so that other component modules can take data (a real number value of a complex FFT) stored in the output register 1036. For example, as shown in FIG. 4, when the FFT unit 412 generates the output enable signal FFT_EN, the Control unit 402 controls the output data of the FFT unit 412 to be stored in the REG file unit 404.

Since execution of the command FFTFI is similar to that of the command FFTFR, this will not be described in detail.

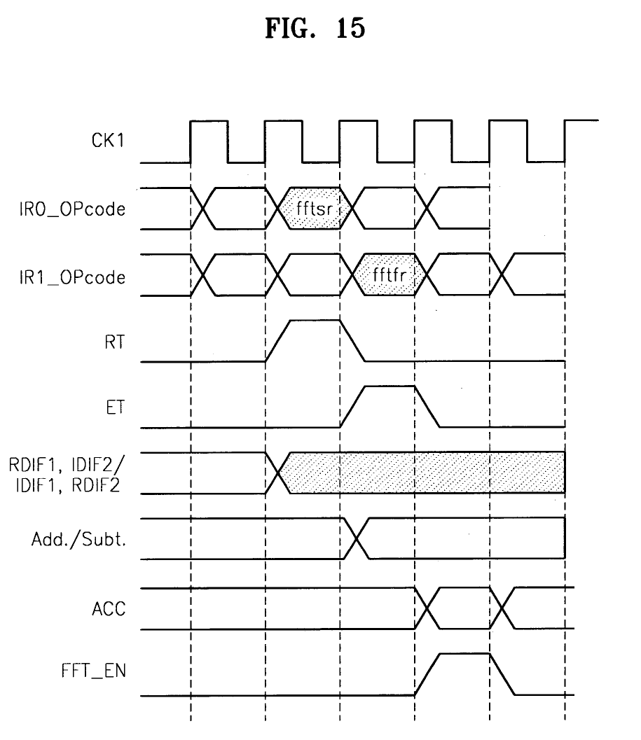

FIG. 15 is a timing diagram for illustrating execution of the command FFTSR. In FIG. 15, the top signal is a clock signal CK1, sequentially followed by a control command applied to the OPcode bus 0, a control command applied to the OPcode bus 1, a signal RT, a signal ET, data applied to the read buses A and B, data applied to the storage registers 1024, 1026, 1028, and 1030, data applied to the adder 1014 and the subtractor 1016, data applied to the output register 1036, and an output enable signal FFT_EN.

When a control command FFTSR is applied to the OPcode bus 0 and the controller 1034 is enabled by a signal RT, the controller 1034 decodes the control command and enters into a stand-by status for an FFT calculation. Thereafter, if a command FFTFR is applied to the OPcode bus 1 and the controller 1034 is enabled by a signal ET, the controller 1034 performs a control operation to achieve the fourth cycle.

To be more specific, the controller 1034 controls the first and second multiplexers 1010 and 1012 to provide the data stored in the storage registers 1024 and 1026 to the subtractor 1016. The controller 1034 also controls the subtractor 1016 to operate a subtraction and the third multiplexer 1032 to store the operation result of the subtractor 1016 in the output register 1036.

Next, the controller 1034 outputs the output enable signal FFT_EN so that other component modules can take data (a real number value of a complex FFT) stored in the output register 1036.

Since execution of the command FFTSI is similar to that of the command FFTSR, this will not be described in detail.

The output register 1036 sequentially stores and output a real number value obtained through the fourth cycle and an imaginary number value obtained through the fifth cycle. If values stored in the output register 1036 overflows, they are scaled and then output.

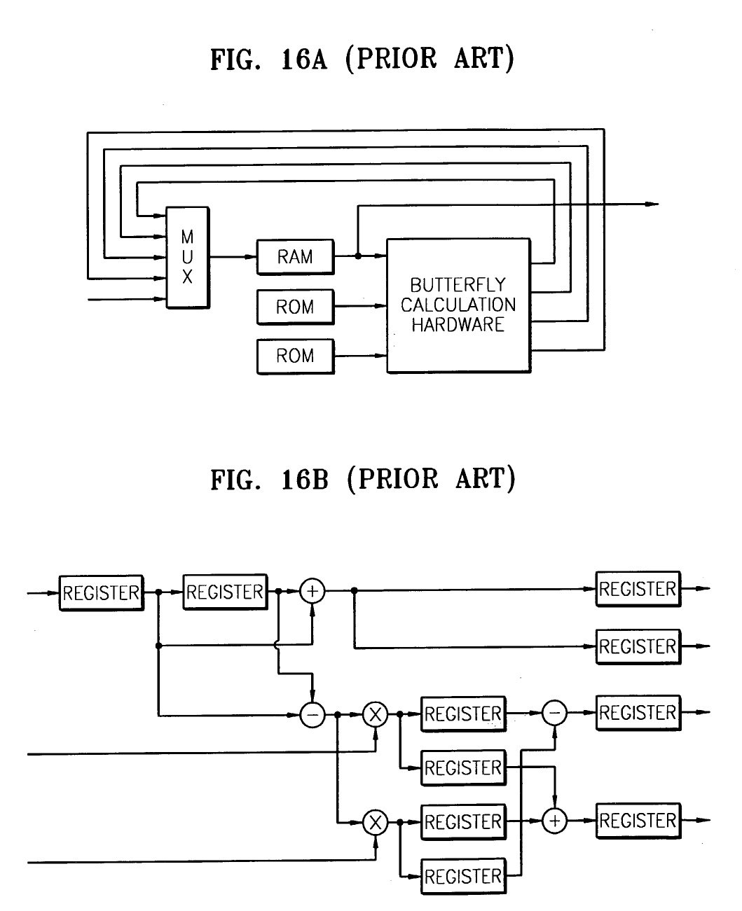

FIGS. 16A and 16B show examples of conventional FFT calculation devices, which are disclosed in Japanese Patent Publication No. hei 06-060107. The devices of FIGS. 16A and 16B are hardware in which butterfly computers are embodied. The butterfly calculation hardware requires a dedicated coefficient memory and a coefficient address computer for the dedicated coefficient memory. In order to compute an FFT of 2 data points, the device of FIG. 16A requires 16 cycles, and the device of FIG. 16B requires 6 cycles.

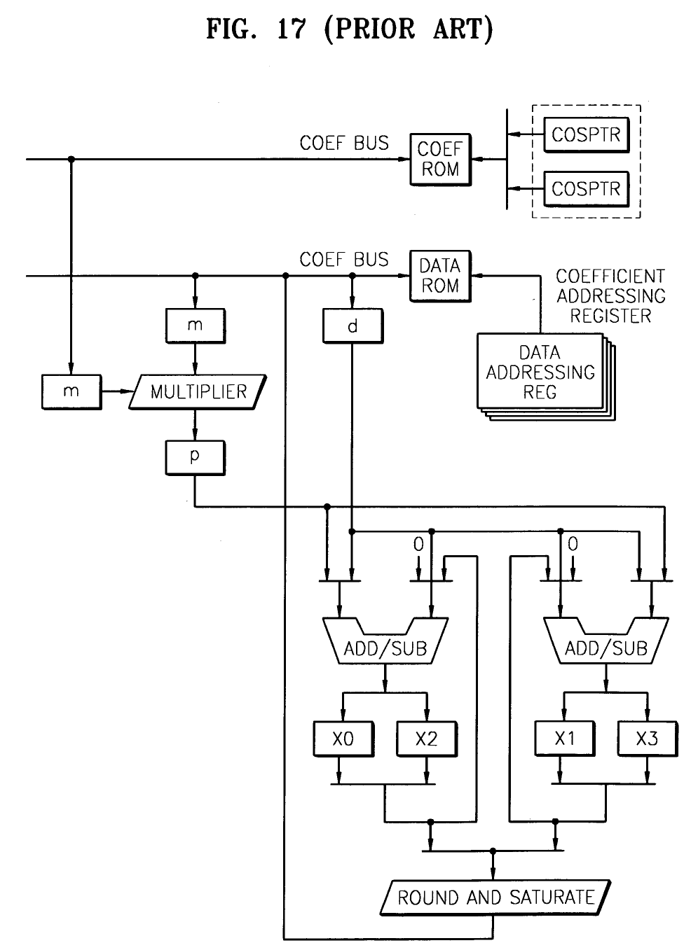

FIG. 17 shows another example of a conventional FFT calculation device, which is disclosed in Korean Patent Publication No. 1999-0079171. The device of FIG. 17 simply has a multiplier and two adders but requires a dedicated coefficient memory, coefficient address registers for the dedicated coefficient memory, and data addressing registers used to address data points. In order to compute an FFT of 2 data points, the device of FIG. 17 requires 9 cycles.

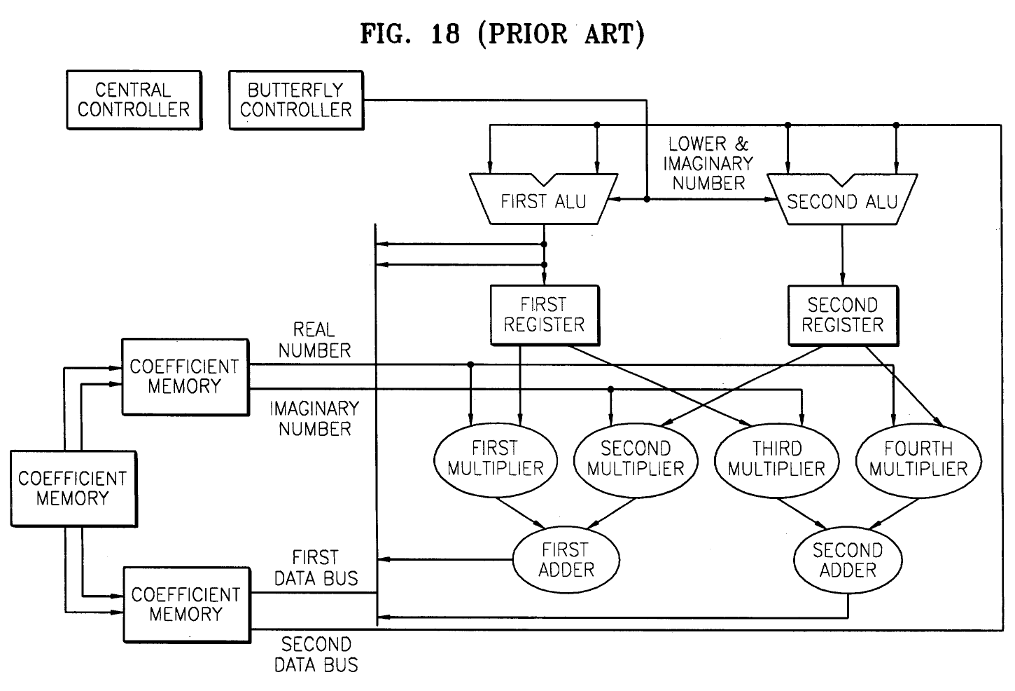

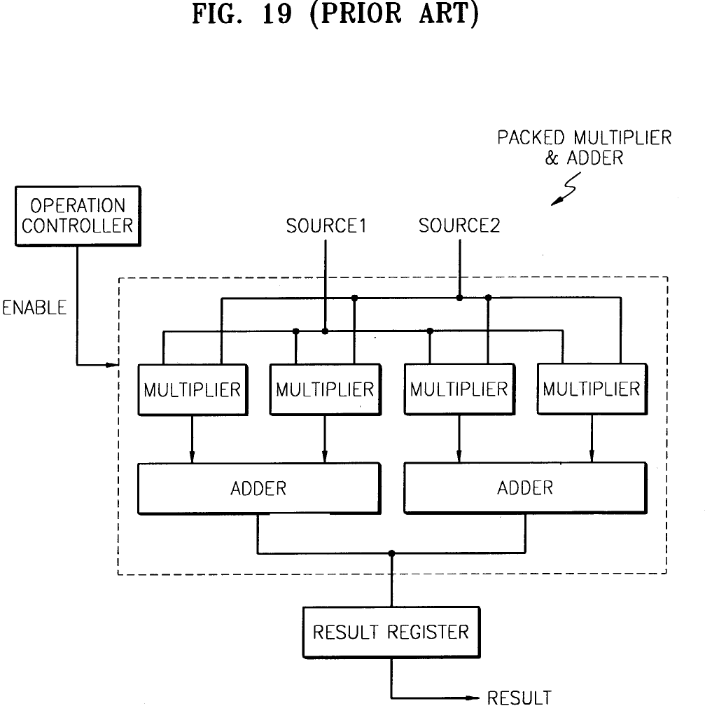

FIG. 18 shows still another example of a conventional FFT calculation device, which is disclosed in Korean Patent Publication No. 2001-0036860. The device of FIG. 18 is constituted of four multipliers, two adders, two ALUs, one read/write bus, and 2 read buses for coefficients and requires at least about 6 cycles.

FIG. 19 shows yet another example of a conventional FFT calculation device, which is disclosed in Japanese Patent Publication No. sho 63-086048. The device of FIG. 19 adopts an Intel MMX processor, is constituted of four multipliers, two adders, and an additional adder (U and V pipelines), and requires 16 cycles/2(pipeline).

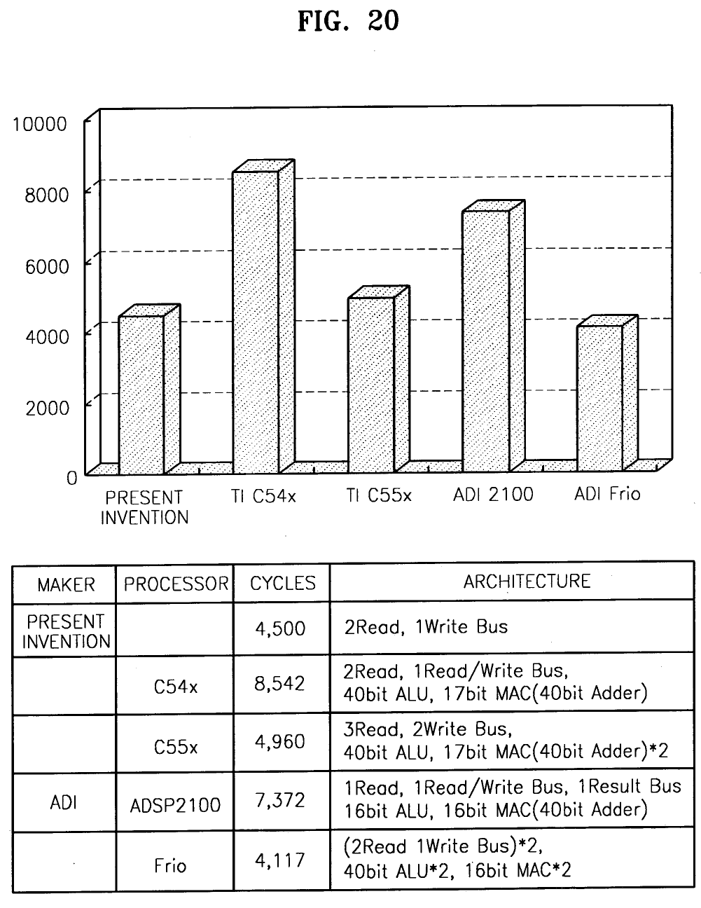

FIG. 20 shows the results of a calculation of an FFT of a 256-point data block using the complex FFT calculation device of FIG. 10 compared to various conventional devices. In the graph of FIG. 10, the vertical axis denotes the number of cycles required for an FFT calculation. Referring to FIG. 20, T1 C54X requires 8,542 cycles, TIC55X requires 4,960 cycles, ADI 2100 requires 7,372 cycles, Frio requires 4,117 cycles, and the FFT calculation device according to an embodiment of the present invention requires 4,500 cycles.

The FFT calculation device according to an embodiment of the present invention is about 1.9 times faster than T1 C54X and about 1.6 times faster than ADI 2100 and provides a better performance than a 5-bus system (3 read buses+2 write buses) like TI C55X.

Meanwhile, since TI C55X has 3 read buses and 2 write buses, TI C55X adopts a pair of general-purpose 3-bus systems. Accordingly, it is manifest that the FFT calculation device according to an embodiment of the present invention is more excellent in compatibility and simplicity than the TI C55X.

That is to say, the FFT calculation device according to an embodiment of the present invention can minimize the number of cycles required for an FFT calculation while maintaining compatibility with a general-purpose 3-bus system.

The difference in data processing speed between a conventional CPU and a main memory is about 100 times or greater, and this difference is compensated by a cache memory.

A cache first reads a series of data expected to be required next by a CPU from a main memory and then stores the read data. Such a cache has a faster access speed than that of the main memory.

The CPU accesses the cache to obtain desired data before accessing the main memory. The hit rate of the expectation of the cache is actually very high, thus contributing to a fast execution of programs.

In a general cache processing method, a block with a cache miss is read from the main memory and exchanged with a new block. Here, a cache is efficiently designed in consideration of the size of a cache, a block mapping method, a block exchanging method, a writing method, and the like. In general, a block exchange is based on a hit rate (or the usage rate of a block).

Typically, a repetition command has a high hit rate. However, programs constituted of a series of repeated long codes, such as, interrupt vectors or interrupt service routines, have a lower hit rate than the hit rate of the repetition command.

When a cache policy based on a hit rate is used, interrupt vectors or interrupt service routines may have a great difference in an interrupt latency because of the attribute of interrupts that they occur nonperiodically and unspecifically. Here, the interrupt latency denotes a lapsed time from when an interrupt occurs to when a service corresponding to the interrupt starts. Also, an interrupt may have different interrupt latencies.

Consequently, the cache policy based on a hit rate is not suitable for a real time processing system that always requires a short interrupt latency.

Since a conventional cache is controlled in a hardware fashion, it cannot utilize adequate cache policies with a change in the circumstances.

For example, the control of a cache in a hardware fashion means that a cache is controlled by a built-in algorithm. Since the built-in algorithm of a cache is fixed upon the manufacture of the cache, the cache is only controlled in a fixed way regardless of a future change in the circumstances.

Some advanced caches can selectively utilize one of several cache policies in a switching implenetation or a mode control implementation but still cannot freely utilize various cache policies.

The above limit requires a cache to be controlled in a software fashion. That is, a free change of a cache controlling implementation without adhering to a hardware-fashion controlling implementation pre-set in a cache is required for a cache to utilize various cache policies.

Meanwhile, a cache can be classified into a command cache or a data cache. The data cache processes data to be manipulated, and the command cache processes commands for controlling a CPU.

The data cache is used as a buffer which processes image data on a frame-by-frame basis in an image-processing device or as a buffer for controlling an input/output speed in an audio processing device.

The command cache is used for the purpose of processing a next command to minimize the interrupt latency in real time processing systems.

With an increase in the integration degree of an LSI (large scale integration) device, conventional embedded systems of a board level are embodied into systems-on-chips (SOCs). SOCs enable a fast transmission by reducing a delay caused upon a data transmission between chips and can reduce the amount of consumed power to a half or less than the amount of power consumed in conventional embedded systems of a board level. Accordingly, SOCs are considered as a next-generation semiconductor designing technique.

In particular, owing to an improvement in system performance and a reduction in board size due to the integration of chips, SOCs enable a reduction of the system manufacturing costs by 20% or greater in respect of a cost performance.

For this reason, SOCs are widely used in network equipment, communication apparatuses, personal digital assistants (PDAs), settop boxes, and digital versatile discs as well as graphic controllers for PCs. Hence, main worldwide semiconductor manufacturers are actively developing SOCs.

If conventional embedded systems of a board level are implemented using SOCs, it is anticipated that real time operating systems (RTOSs) based on interrupts are to be prevalently used.

On the other hand, if general caches are used in conventional embedded systems of a board level, since general caches include neither a process control block (PCB) nor an interrupt service routine, the performance of the entire system may be degraded.

Accordingly, one-chip real time processing systems need to minimize the interrupt latency.

A cache according to an embodiment of the present invention can control various cache policies in a software fashion.

A cache controlling method according to an embodiment of the present invention is characteristic in using an updating pointer. In practice, the internal memory of a cache is blocked, and the updating pointer indicates each memory block. A memory block indicated by the updating pointer can be exchanged with another memory block. That is to say, the updating pointer denotes one of the memory blocks of a blocked internal memory, and a memory block indicated by the updating pointer can be exchanged with a new memory block when a cache miss occurs.

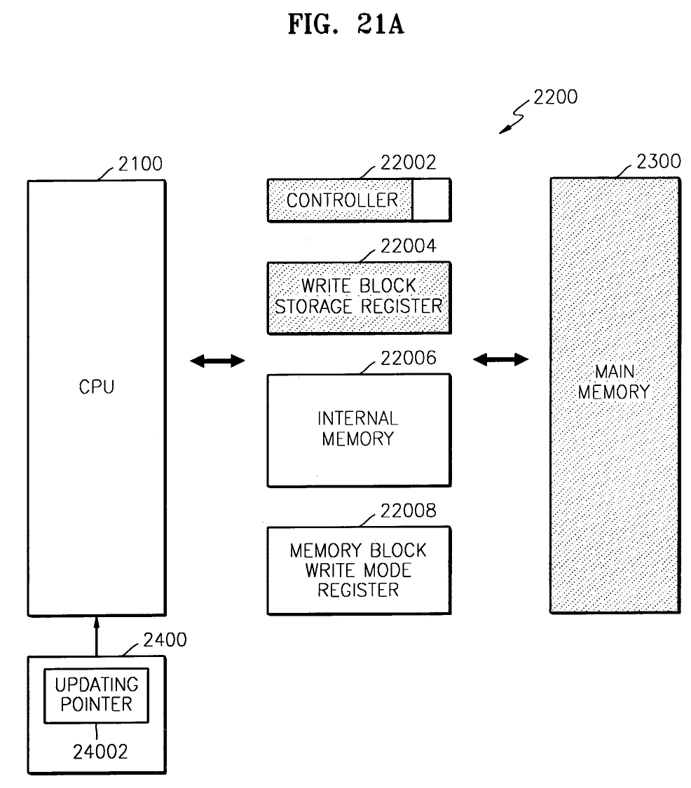

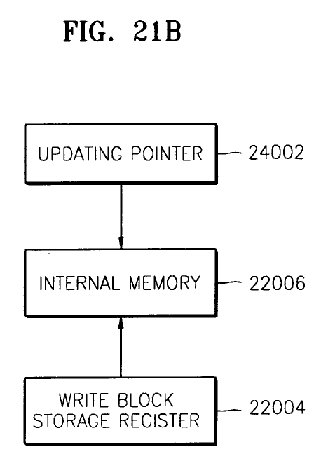

FIGS. 21A and 21B are block diagrams for illustrating a method of controlling a cache used in a voice recognition device according to an embodiment of the present invention. In FIG. 21A, reference numeral 2100 denotes a CPU, reference numeral 2200 denotes a cache, reference numeral 2300 denotes a main memory, and reference numeral 2400 denotes a cache-controlling program.

The cache 2200 first reads a series of data anticipated to be required next by the CPU 2100 from the main memory 2300 and then stores the read data.

The cache 2200 includes a controller 22002, a write block storage register 22004, and an internal memory 22006. The write block storage register 22004 indicates the location of a block to be updated upon a block exchange performed in the internal memory 22006.

The internal memory 22006 is blocked. Among memory blocks, a memory block indicated by the write block storage register 22004 or an updating pointer 24002 is exchanged with a new memory block.

FIG. 21B illustrates a block exchange operation associated with the updating pointer 24002 and the write block storage register 22004. The internal memory 22006 comprises a plurality of memory blocks. The updating pointer 24002, which is a variable of the cache-controlling program 2400, indicates one block out of a plurality of memory blocks. The memory block indicated by the updating pointer 24002 can be exchanged with a new memory block when the cache 2200 is controlled by the cache-controlling program 2400.

The updating pointer 24002 is a variable used within a program, and the value of the updating pointer 24002, e.g., a value indicating a memory block to be exchanged, is determined by software, e.g., determined by the cache controlling program 2400, which operates outside the cache 2200.

A memory block to be exchanged can be determined in a hardware fashion. Such a memory block determination in a hardware fashion denotes a determination made by the algorithm of the cache 2200, that is, an algorithm programmed upon the manufacture of the cache 2200. Accordingly, the cache 2200 itself is not elastic enough to respond to a change in the circumstances since an operation algorithm is fixed upon the manufacture of the cache 2200. However, if an external program determines whether a memory block is to be updated, the cache 2200 is able to elastically respond to a change in the circumstances.

The cache-controlling program 2400 may be loaded in the main memory 2300, loaded from the main memory 2300 to the cache 2200, or loaded in a special memory.

FIG. 21B shows the updating pointer 24002 and the write block storage register 22004. A value stored in the write block storage register 22004 represents a memory block determined by the cache 2200 itself to be exchanged.

Accordingly, the updating pointer 24002 and the write block storage register 22004 must be prioritized. In the present invention, the updating pointer 24002 has a higher priority level than the write block storage register 22004. Thus, if the cache 2200 is controlled by the cache-controlling program 2400, information stored in the write block storage register 22004 is ignored.

In some cases, an update of each memory block must be prohibited. For example, a memory block that stores indispensable data must be set not to be updated.

A memory block write mode register 22008 is shown in FIG. 21A. The value of the memory block write mode register 22008 varies in a hardware or software fashion. For example, upon the initialization of the cache 2200, which is one of a plurality of initialization operations for driving a system with the constituent elements shown in FIG. 21A, the most basic and indispensable data from the main memory 2300 is loaded in the first memory block of the internal memory 22006, and simultaneously the first memory block is set to be write-prohibited.

The contents stored in the memory block write mode register 22008 is always referred to in the hardware update. However, if the cache 2200 is controlled by the cache controlling program 2400 which operates outside the cache 2200, the information set in the memory block write mode register 22008 upon the hardware control is ignored.

Whether a cache is controlled in a hardware or software fashion is determined by a CPU. For example, the CPU monitors a cache-hit rate and determines whether the cache-hit rate is maintained at a predetermined value or greater even only by a hardware cache control, e.g., by a control using the built-in algorithm of a cache. If the cache hit rate decreases to a predetermined value or smaller, the CPU controls the cache to perform a block exchange in a software fashion, e.g., using a program that operates outside the cache.

The cache-controlling program 2400 controls the cache 2200 according to a command. A command generated by the cache-controlling program 2400 is provided to the cache 2200. The controller 22002 of the cache 2200 decodes the command and controls the operation of the cache 2200 according to the decoded command.

Through this command, the cache controlling program 2400 controls the block exchange operation of the cache 2200 and determines whether each memory block is set to be prohibited from being written to.

In such a cache controlling method according to an embodiment of the present invention, a memory block to be exchanged upon block exchange can be adaptively determined by a program that operates outside a cache. Thus, a change in a cache policy depending on changing circumstances can be elastically made.

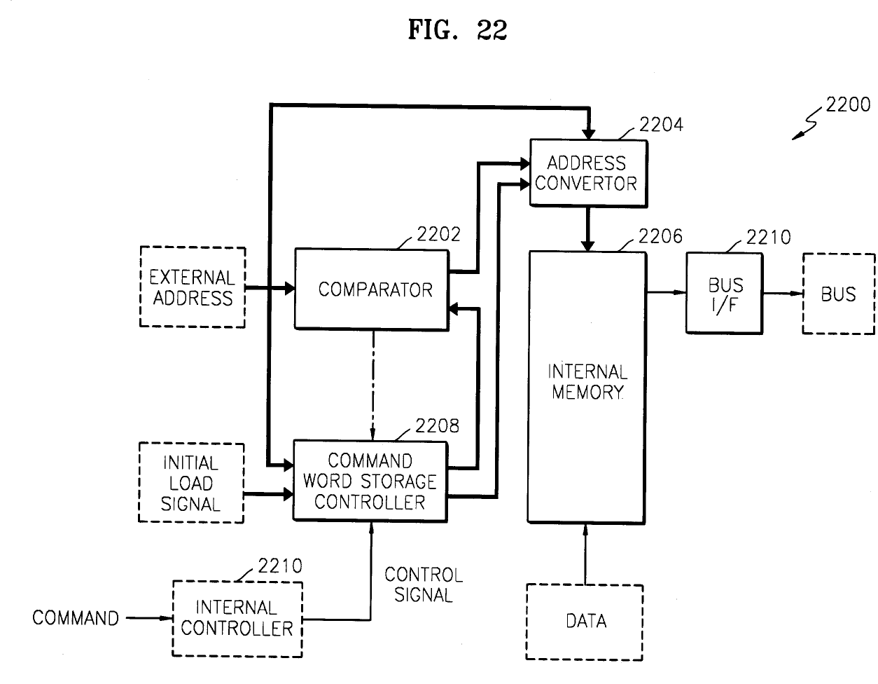

FIG. 22 is a block diagram of the cache 2200 used in a voice recognition device according to an embodiment of the present invention. The cache 2200 of FIG. 22 is implemented within the PMIF 422 of FIG. 4.

The cache of FIG. 22 includes a comparator 2202 for comparing an external address applied to the cache 2200 with an external address stored in the internal memory 2206, an address converter 2204 for converting an external address into an internal address for accessing the internal memory 2206, a command word storage controller 2208 for loading data from an external memory to the internal memory 2206, and a bus interface (I/F) 2210 for interfacing the internal memory 2206,with a bus.

Here, the external memory typically denotes a main memory but is not definitely limited to this denotation. The external address denotes an address used when a CPU accesses a main memory. The internal address denotes an address used to access the internal memory 2206 built in a cache.

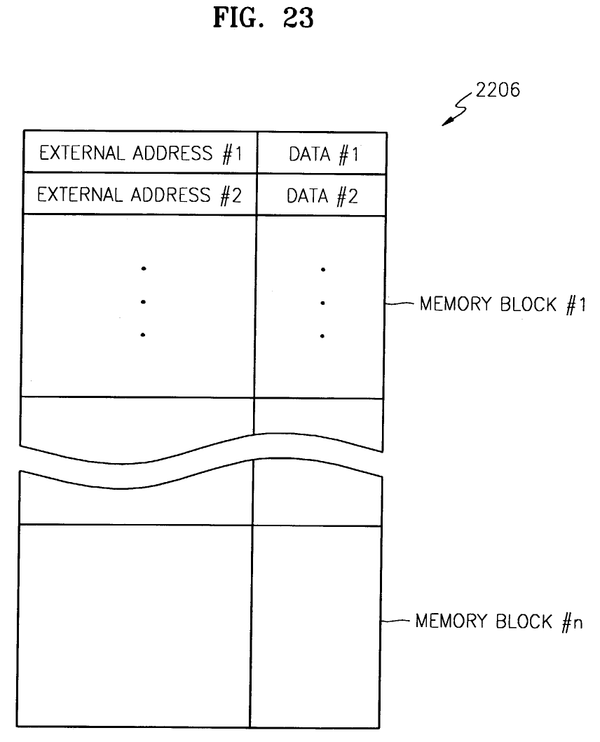

FIG. 23 shows the stored contents of the internal memory 2206 in the cache of FIG. 22. As shown in FIG. 23, the internal memory 2206 stores both the address of an external memory (e.g., an external address) and data of the address. The external address stored in the internal memory 2206 is compared with the external address applied to the cache 2200.

The internal memory 2206 is composed of a plurality of memory blocks #1 through #n.

The CPU 2100 of FIG. 21A first accesses the cache 2200 before accessing the main memory 2300. That is, the CPU 2100 requests data from the cache 2200 by applying an external address for accessing the main memory 2300 to the cache 2200. The cache 2200 compares the received external address with the external address stored in the internal memory 2206. If the same external address as the received external address is detected from the internal memory 2206, the cache 2200 reads data associated with the detected external address from the internal memory 2206 and provides the data to the CPU 2100 or records data provided by the CPU 2100.

Since the cache 2200 can be accessed faster than the main memory 2300, the CPU 2100 can transmit data to and receive data from the cache 2200 faster than from the main memory 2300.

On the other hand, if the internal memory 2206 has no external addresses identical to the received external address, a cache miss occurs. In this case, the CPU 2100 accesses the main memory 2300.

If a cache miss occurs, the cache 2200 accesses the main memory 2300, reads data corresponding to the place where a cache miss has occurred (e.g., a place indicated by an external address), and updates the internal memory 2206 one memory block at a time.

A conventional cache exchanges memory blocks in a fixed sequence. For example, every time a cache miss occurs, memory blocks are sequentially exchanged, for example starting from the first memory block, the second memory block, and the third memory block to the last memory block. According to this memory block exchange implementation, even when a memory block to be exchanged stores data with a high hit rate or important data, the memory block must be exchanged.

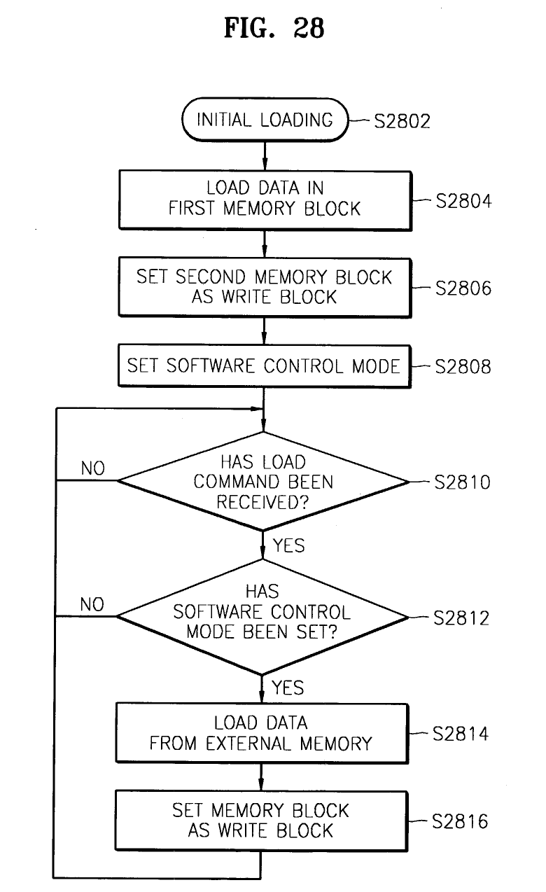

However, as will be described with reference to FIG. 28, a cache according to an embodiment of the present invention can adequately select a memory block to be exchanged depending on the significance or priority of data.

In the cache shown in FIG. 22, the internal memory 2206 is blocked, and each of the memory blocks stores a series of data, for example, interrupt vectors or interrupt service routines.

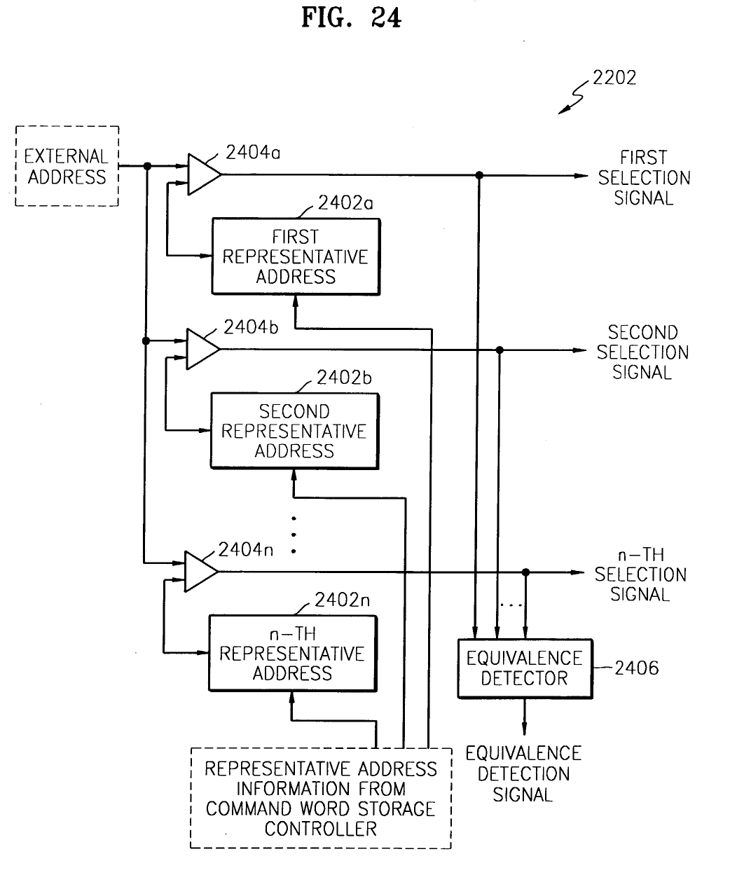

FIG. 24 is a block diagram showing a structure of the comparator 2202 of FIG. 22 in greater detail. The comparator 2202 includes representative address registers 2402a through 2402n, comparators 2404a through 2404n, and an equivalence detector 2406. The comparators 2404a through 2404n compare external addresses with first through n-th representative addresses respectively stored in the representative address registers 2402a through 2402n to generate first through n-th selection signals representing whether the external addresses are equal to the first through n-th representative addresses. The equivalence detector 2406 detects whether the external addresses stored in the internal memory 2206 are equal to those applied to the cache 2200. Here, n is the number of memory blocks of the internal memory 2206.

The representative address registers 2402a through 2402n are controlled by the command word storage controller 2208 of FIG. 22 and store representative addresses provided by the command word storage controller 2208.

Here, a representative address denotes a head address among the external addresses stored in the memory blocks. Typically, a main memory is composed in units of a byte (8 bits), and a bus is composed in units of more than one byte. If a bus is composed in units of 4 bytes (32 bits), 4 bytes (4 addresses) are typically read at a time to improve the access speed. If only a head address is indicated, four addresses including the head address are automatically and consecutively processed.

That is to say, it can be considered that a main memory is blocked to a size as large as at least the width of a bus. However, since 4 bytes are actually very small, frequent memory block exchanges may occur. Hence, an actual memory block is blocked in units that are much larger than 4 bytes.

Accordingly, the representative address registers 2402a through 2402n each have the head address among the external addresses stored in each of the memory blocks. Particularly, the upper part of a head address is stored in each of the representative address registers 2402a through 2402n.

The comparators 2404a through 2404n compare the upper parts of external addresses with the upper parts of the head addresses stored in the representative address registers 2402a through 2402n, respectively. Depending on the results of the comparison, first through n-th selection signals representing whether the external addresses are equal to the representative addresses are generated. The generated first through n-th selection signals are provided to the address converter 2204 of FIG. 22.

The generated first through n-th selection signals are also provided to the equivalence detector 2406, which determines, using the first through n-th selection signals, whether a cache miss occurs. If all of the first through n-th selection signals represent that the external addresses are not equal to the representative addresses, a cache miss has occurred.

An equivalence detection signal output from the equivalence detector 2406 is provided to the address converter 2204 of FIG. 22, which determines whether the internal memory 2206 or an external memory (i.e., the main memory 2300) is accessed.

The equivalence detection signal output from the equivalence detector 2406 is also provided to the command word storage controller 2208 of FIG. 22. Based on the equivalence detection signal, the command word storage controller 2208 determines whether a cache miss has occurred. Depending on the result of the determination, a memory block exchange is performed.

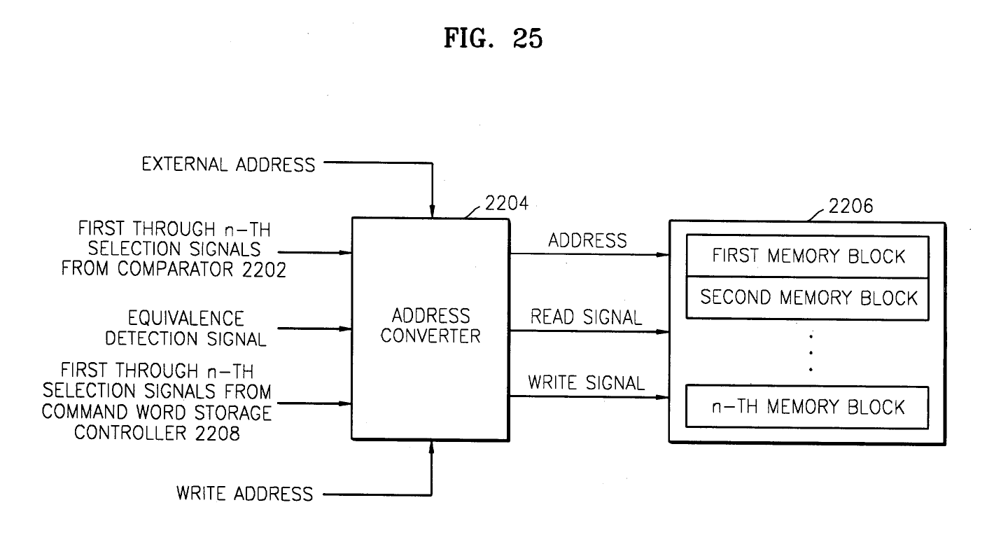

FIG. 25 is a block diagram for illustrating the operation of the address converter 2204 of FIG. 22. Referring to FIG. 25, the address converter 2204 receives an external address, first through n-th selection signals from the comparators 2204a through 2204n, first through n-th selection signals from the command word storage controller 2208, and a write address and generates an address and a read/write control signal for the internal memory 2206.

The operation of the address converter 2204 when a cache hit occurs will now be described. Whether a cache hit has occurred is determined by the equivalence detection signal from the comparator 2202 of FIGS. 22 and 24. If a cache hit has occurred, e.g., if the equivalence detection signal from the comparator 2202 represents equivalence, the address converter 2204 converts the received external address into an internal address for the internal memory 2206 with reference to the first through n-th selection signals from the comparators 2404a through 2404n and provides the internal address to the internal memory 2206. The address converter 2204 also generates an internal memory control signal, such as, a read/write signal.

Since the mapping of an external address with an internal address can be changed at any time depending on the type of memory used as the internal memory 2206 and other matters to be considered upon design, the mapping will not be described in detail.

This time, the operation of the address converter 2204 when a cache miss has occurred will now be described.

Whether a cache miss has occurred is determined by the equivalence detection signal from the comparator 2202 of FIGS. 22 and 24. If a cache miss has occurred, the CPU 2100 secondarily accesses an external memory, e.g., the main memory 2300. Thereafter, the command word storage controller 2208 of FIG. 22 performs a block exchange. Upon the block exchange, the address converter 2204 generates an internal memory address for accessing the internal memory 2206 by referring to the first through n-th selection signals and the write address that are provided from the command word storage controller 2208. Here, the first through n-th selection signals from the command word storage controller 2208 determine the upper address of the internal address, and the write address from the command word storage controller 2208 determined the lower address of the internal address.

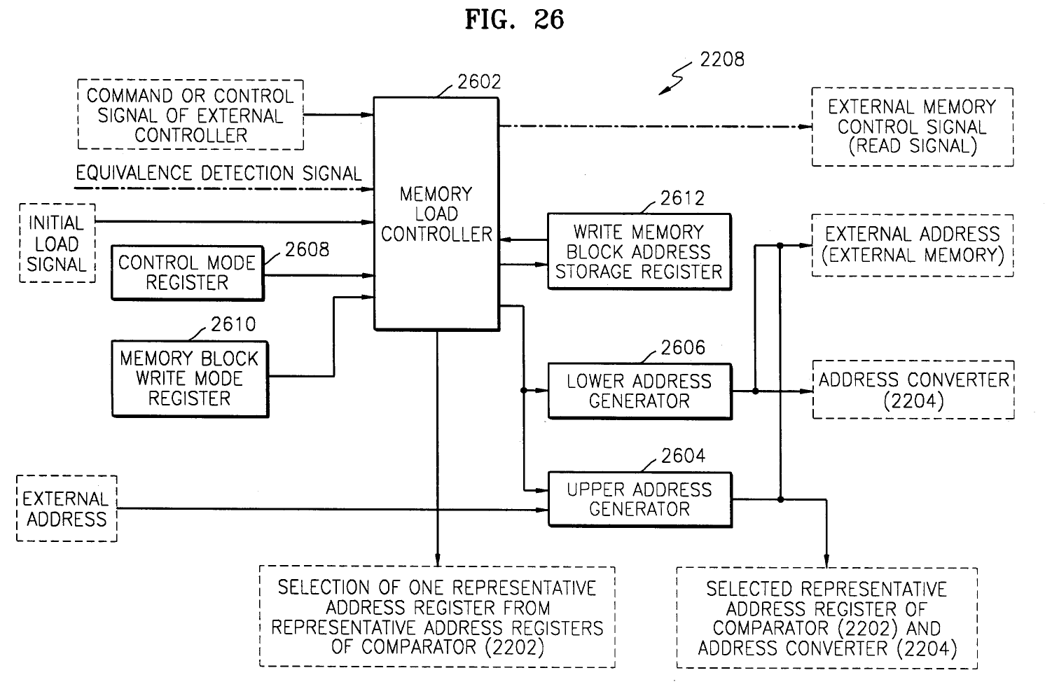

FIG. 26 is a block diagram showing a structure of the command word storage controller 2208 of FIG. 22. The command word storage controller 2208 includes a memory load controller 2602, an upper address generator 2604, a lower address generator 2606, a control mode register 2608, a memory block write mode register 2610, and a write memory block address storage register 2612.

The operation of the command word storage controller 2208 is determined by the equivalence detection signal provided by the equivalence detector 2406 of FIG. 24. If the equivalence detection signal represents nonequivalence, the command word storage controller 2208 performs a block exchange.

The block exchange is performed in a hardware fashion (a hardware control mode) or in a software fashion (a software control mode).

In the hardware control mode, memory blocks are exchanged in a predetermined sequence.

Information relating to a memory block to be exchanged next is stored in the write memory block address storage register 2612. The memory load controller 2602 generates first through n-th representative addresses to be provided to the representative address registers 2402a through 2402n of FIG. 24 and the write address to be provided to the address converter 2204 of FIG. 25, with reference to the information stored in the write memory block address storage register 2612.

A memory block to be exchanged is informed by the write memory block address storage register 2612. The memory load controller 2602 selects a memory block from the representative address registers 2402a through 2402n by referring to the information stored in the write memory block address storage register 2612. The memory blocks and the representative address registers 2402a through 2402n have a one-to-one correspondence.

The upper address generator 2604 generates a representative address to be stored in the selected representative address register with reference to the external address. To be more specific, the upper address generator 2604 generates the representative address by taking the upper address of the external address. The generated representative address is provided to the selected representative address register.

The lower address generator 2606 generates a write address to be provided to the address converter 2204 under the control of the memory load controller 2602. The lower address generator 2606 is initialized to “0” and updated by one every time data is loaded from the external memory.

The external address used for the cache 2200 to access the external memory, e.g., the main memory 2300, is obtained by combining the upper address generated by the upper address generator 2604 and the lower address generated by the lower address generator 2606.

The memory load controller 2602 generates an external memory control signal, such as, a read/write signal.

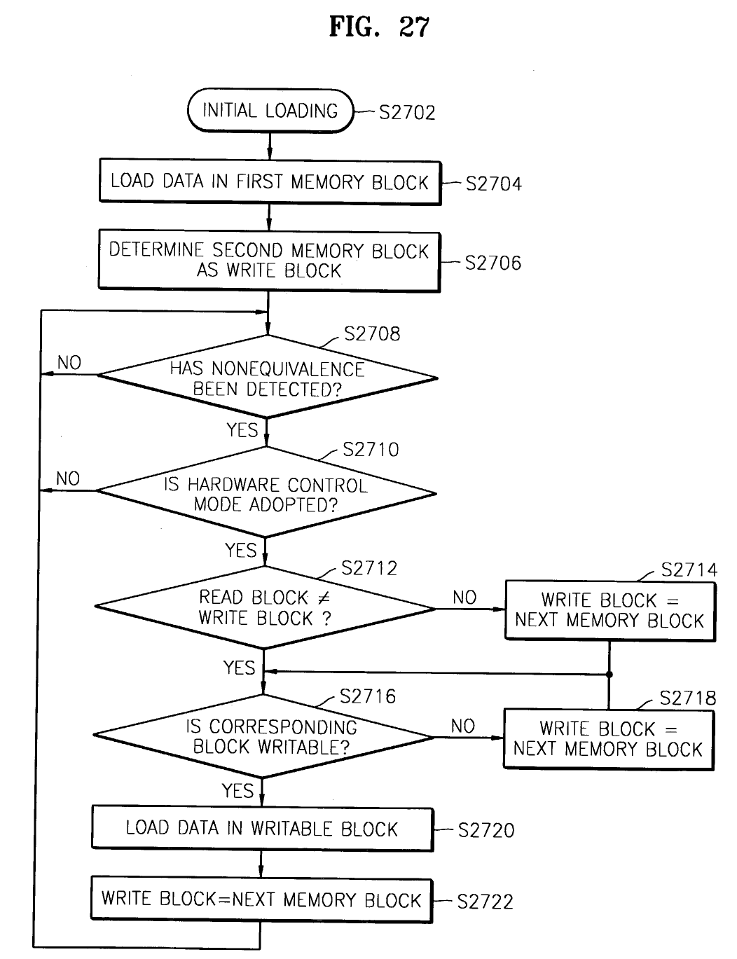

FIG. 27 is a flowchart illustrating an operation of the cache 2200 of FIG. 22 in a hardware control mode. FIG. 27 shows the simplest example of a block exchange operation in which memory blocks are exchanged in a sequence from a first memory block to an n-th memory block.

In step s2702, an initial loading is performed. The initial loading is driven by an initial load control signal to be described later and performed in the initialization stage of a system.

After the initial loading is designated, data is loaded in the first memory block in step s2704. That is to say, as much data as one block is read from the main memory 2300 of FIG. 21A and loaded in the first memory block of the internal memory 22006.

A second block is determined as a write block, in step s2706. Information regarding the determination of the write block is stored in the write memory block address storage register 2612.

In step s2708, it is determined whether nonequivalence has been detected. If the equivalence detection signal generated by the equivalence detector 2406 of FIG. 24 represents nonequivalence, it is determined that nonequivalence has been detected.

In step s2710, it is determined whether a hardware control mode is adopted, by referring to the contents set in the control mode register 2608 of FIG. 26.

If the hardware control mode will be adopted, it is determined in steps s2712 and s2714 whether a read block is equal to a write block. The steps s2712 and s2714 are performed to prevent wrong writing.

In step s2716, it is determined whether a block to be written is writable. This determination can be made by referring to the contents set in the memory block write mode register 2610 of FIG. 26. If the block to be written is set to be unwritable, a next memory block is set as a write block, in step s2718.

If the block to be written to is set to be writable, data is loaded in the write block, in step s2720. In other words, as much data as one block is read from the main memory 2300 of FIG. 21A and loaded in a write memory block of the internal memory 22006.

In step s2722, the next memory block is set to be a write block.

A block exchange based on a software control mode will now be described. In the software control mode, a memory block to be exchanged is determined depending on all circumstances in a software fashion.

If the software control mode is adopted, a memory block with a high hit rate or a memory block with important data can be avoided from being replaced. Thus, the cache 2200 can be efficiently operated.

When the hardware control mode is used, the upper address generator 2604 is just a buffer. However, when the software control mode is used, the upper address generator 2604 plays a significant role.

FIG. 28 is a flowchart illustrating the operation of an cache 2200 of FIG. 22 in a software control mode. In the software control mode of FIG. 28, all memory blocks are set to be writable regardless of the contents set in the write memory block address storage register 2612, and a writable mode for individual memory blocks is entirely managed in a software fashion. In addition, data can be loaded in the internal memory 2206 by just performing a command without a determination of equivalence or nonequivalence.

In step s2802, an initial loading is performed. The initial loading is driven by an initial load control signal to be described later and performed in the initialization stage of a system.

After an initial loading is designated, data is loaded in the first memory block in step s2804. That is to say, as much data as one block is read from the main memory 2300 of FIG. 21A and loaded in the first memory block of the internal memory 22006.

A second memory block is determined as a write block, in step s2806.

In step s2808, a software control mode is set. In the software control mode, all memory blocks are set to be writable regardless of the contents set in the write memory block address storage register 2612, and a writable mode for individual memory blocks is entirely managed in a software fashion. In addition, data can be loaded in the internal memory 22006 by just performing a command without a determination of equivalence or nonequivalence.

In step s2810, it is determined whether a load command has been received.

In step s2812, it is determined whether a software control mode has been set.

In step s2814, data from an external memory is loaded in the internal memory 22006.

In step s2816, a memory block in which data is to be loaded next is set as a write block. The memory block in which data is to be loaded next is determined in a software fashion, and thus it is not necessarily the memory block next to the second memory block.

Whether a hardware control mode or a software control mode is to be used is determined by the control mode register 2608 of FIG. 26. If the control mode register 2608 represents a software control mode, information stored in the write memory block address storage register 2612 is ignored, and a memory block to be exchanged is determined by a special program.

To be more specific, a memory block to be exchanged is determined by a command or control signal from an external controller. Here, the external controller typically indicates a CPU, but is not limited to the CPU. The command indicates a command of a microprocessor level, e.g., an OP code.

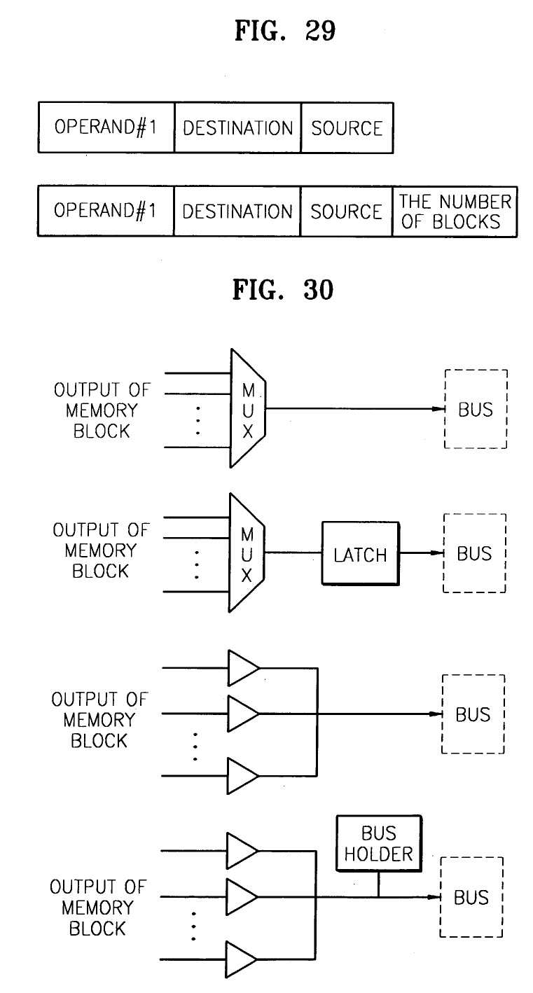

A block exchange operation based on a command from an external controller will now be described. FIG. 29 shows examples of a command word for a block exchange operation. A first example of a command word, which is on the top of FIG. 29, includes an operand, a destination, and a source that indicate a block exchange operation. Here, the source denotes an external memory, and the destination denotes an internal memory.

That is to say, in the first example of a command word, as much data as the storage capacity of a memory block is exchanged between an external memory and an internal memory. The data exchange can be a loading of data from the internal memory to the external memory or a vice versa.

A second example of a command word, which is on the bottom of FIG. 29, includes an operand, a destination, a source, and the number of blocks to indicate a block exchange operation.

That is to say, in the second example of a command word, as much data as the storage capacity of an indicated number of memory blocks is exchanged between an external memory and an internal memory.

A block exchange operation based on a control signal will now be described. Here, the control signal denotes a signal generated by an internal controller for controlling a cache. As described later, it is manifest that a module for implementing the cache 2200 of FIG. 22 includes an internal controller 2210 for decoding a command word and controlling the cache 2200. Such a module for implementing a cache using an internal controller can independently control the cache.

In the command word storage controller 2208 of FIG. 26, an initial load signal serves as a reset signal and is generated in the initial operation stage of a system. When the initial load signal is generated, the memory load controller 2602 initializes the system, and predetermined data are read from the main memory 2300 and loaded in the internal memory 2206. Data to be initially loaded can be data with the greatest usage frequency and the greatest priority, such as, a process control block.

The memory block write mode register 2610 of FIG. 26 is provided to set each memory block to be writable/unwritable. The information stored in the memory block write mode register 2610 is referred to by both the hardware control mode and the software control mode. If a memory block is determined to be unwritable by reference to the information stored in the memory block write mode register 2610, data can be read from the memory block but cannot be written to the memory block.

Hence, a memory block set to be unwritable is not exchanged.

For example, in the initial loading, predetermined data, the amount of which corresponds to one block, from the main memory 2300 of FIG. 21A is loaded in the first memory block of the internal memory 2206. The first memory block may be set to be unwritable.

FIG. 30 shows examples of a structure of the bus interface (I/F) 2210 of FIG. 22. As shown in FIG. 30, the output of a memory block is connected to a bus via a multiplexer or three state buffers. A bus I/F may include a latch or a bus holder.

Here, the bus holder prevents a bus from entering into a floating state and is constituted of a typical buffer as shown in FIG. 30. The bus holder has two inverters connected to each other in such a way that the input of one inverter is coupled to the output of the other inverter and the output of the one inverter is coupled to the input of the other inverter. A signal applied to the bus holder having such a structure maintains the same state because of the two inverters. Consequently, the bus holder prevents the bus from floating.

The bus floating means that the level of a signal is not determined. For example, a gate of a MOS transistor may be connected to the bus. In this case, a large amount of current is consumed at a transition area between 0 and 1. When the bus enters into a floating state, the level of the signal is set in the transition area. Thus, a large amount of power is consumed via the MOS transistor.

The PMIF 422 of FIG. 4 includes a cache according to an embodiment of the present invention as shown in FIG. 22. The PMIF 422 receives a command via the control command buses (OPcode buses 0 and 1), decodes the command, and controls the cache according to an embodiment of the present invention to perform a cache operation. In the mean time, data are received via the two read buses 442 and 444 and output via the write bus 446. Also, a controller (not shown) of the PMIF 422 decodes a received control command and controls the cache to perform a block exchange.

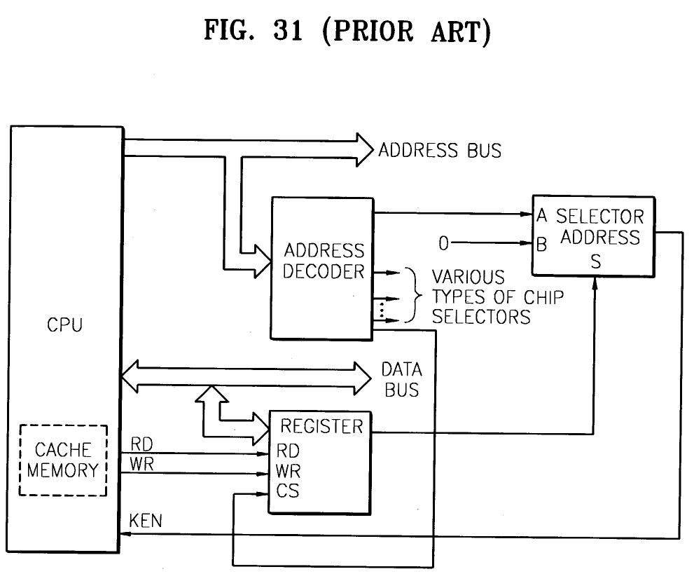

FIG. 31 shows an example of a conventional cache, which is disclosed in Japanese Patent Publication No. hei 10-214228. The cache of FIG. 31 enables a user to determine whether the cache can use a main memory of a voice recognition device. The determination can be made in a hardware or software fashion. To be more specific, the cache is installed at a cache enable input terminal of a CPU so as to operate only when both sides of a page table having a cache enable signal and cacheable information of individual memory blocks are cacheable.

However, in the device of FIG. 21A, when the memory blocks of an internal memory are updated, a memory block to be updated using a write memory block address storage register can be selected in a hardware or software fashion. In this respect, the cache of FIG. 31 is different from the device of FIG. 21A.

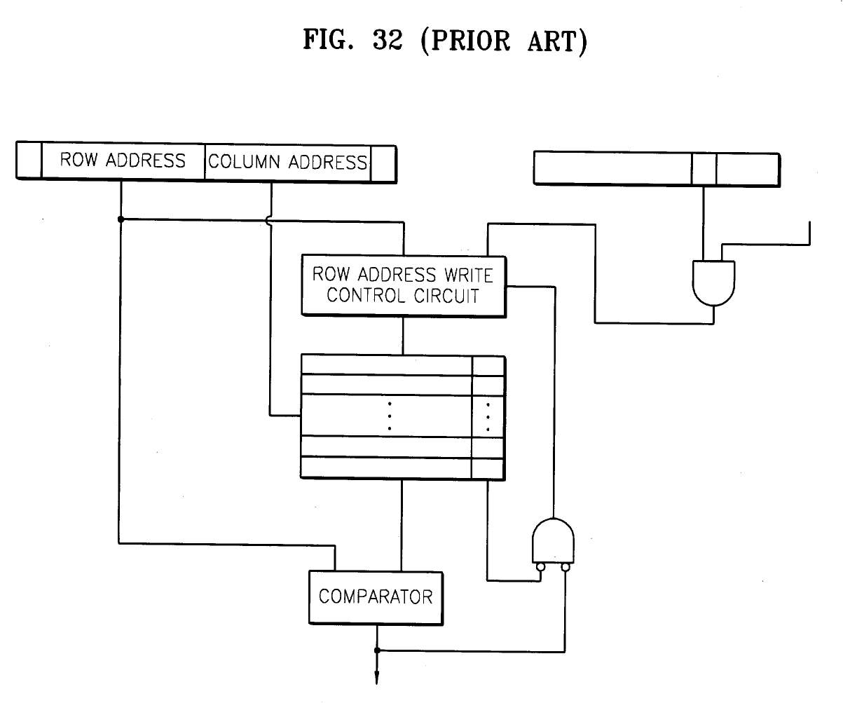

FIG. 32 shows another example of a conventional cache, which is disclosed in Japanese Patent Publication No. sho 60-183652. In the cache of FIG. 32, whether a memory block can be updated is controlled by controlling, in a software fashion, a memory block updating control flag, called a tag, using a unit for memorizing the data stored in a main memory on a block-by-block basis and a unit for memorizing the address of the main memory.

However, in the device of FIG. 21A, individual memory blocks can be updated by controlling a selection pointer used to update memory blocks, e.g., a write memory block address storage register, in a hardware or software fashion. Hence, the cache of FIG. 32 is different from the device of FIG. 21A.

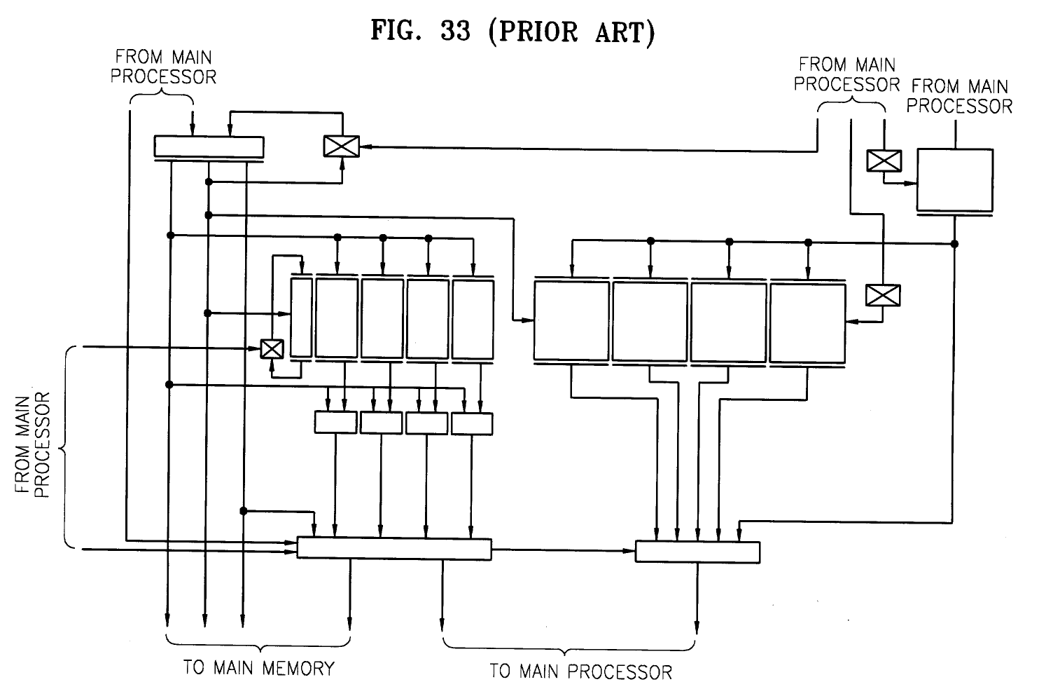

FIG. 33 shows still another example of a conventional cache, which is disclosed in Japanese Patent Publication No. hei 6-67976. The cache of FIG. 33 improves the performance of a command word caching by using a micro-program stored in a main memory.

To be more specific, in the cache of FIG. 33, the frequency of block loading, update preventing, and block load preventing are controlled using three types of micro-program command words having a high-level significance, a middle-level significance, and a low-level significance independently before, while, and after processing of a control software for hardware is executed.

Compared to the device of FIG. 21A, a cache according to an embodiment of the present invention can determine whether a memory block is to be updated both in a hardware fashion and a software fashion and also can simply perform a method of prioritizing or changing commands.

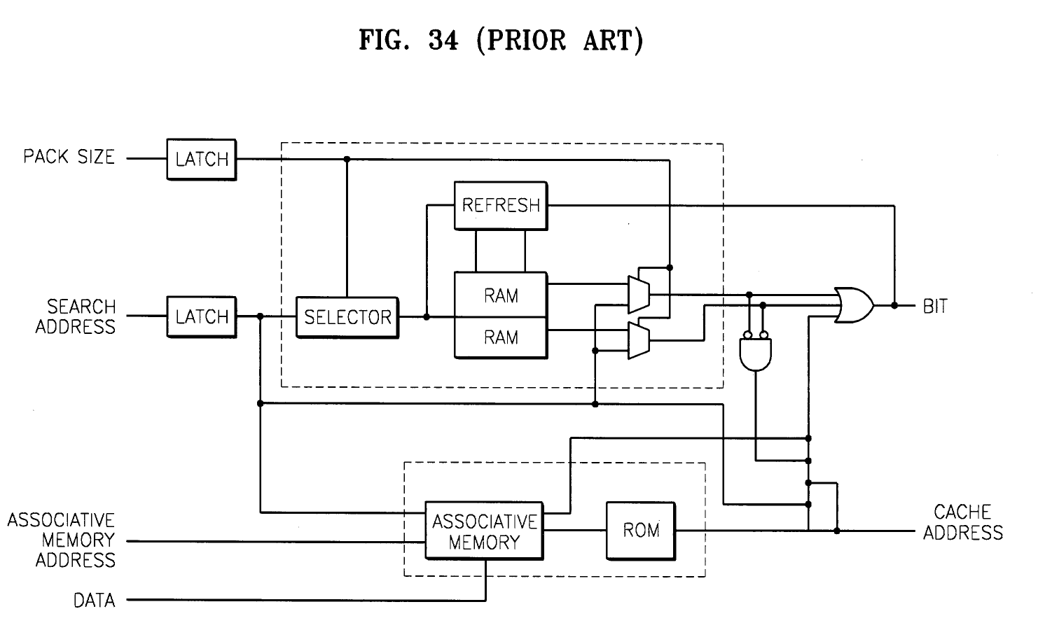

FIG. 34 shows yet another example of a conventional cache, which is disclosed in Japanese Patent Publication No. sho 63-86048. The device of FIG. 34 divides data to be dynamically allocated and data to be statically allocated according to the areas of a cache, thereby improving the hit rate of the cache.

To be more specific, dynamic data required to be frequently updated is stored in a first area of the cache, and the first area is updated several words at a time in a hardware fashion. Static data is stored in a second area of the cache, and the second area is updated several thousands of words at a time in a software fashion.

However, a cache according to an embodiment of the present invention can determine whether data is to be allocated dynamically or statically to each memory block. Hence, the construction of a voice recognition device is elastic.

As described above, a cache according to an embodiment of the present invention in a real-time processing system minimizes an interrupt response time. Also, the cache according to an embodiment of the present invention can perform various caching methods using a hardware control method and a software control method.

Furthermore, compared to conventional caches composed of about 10,000 gates, the cache according to an embodiment of the present invention can be formed of about 2500 gates and is thus adequate for VLSI. Therefore, productivity is enhanced, and the manufacturing costs are reduced.

A voice recognition device according to an embodiment of the present invention includes dedicated calculation devices for performing frequently occurring calculations upon voice recognition, thereby greatly improving the speed of calculations for voice recognition.

In addition, the voice recognition device according to an embodiment of the present invention is adequate for a software system in which operations are easily changed and, at the same time, processes a voice fast.

The voice recognition device according to an embodiment of the present invention adopts a 2-read 1-write implementation and is thus suitable for a general-purpose processor.

The voice recognition device according to an embodiment of the present invention is manufactured in a SOC way and thus improves the performance of the system and reduces the size of a board. Thus, the manufacturing costs are reduced.

Furthermore, the voice recognition device according to an embodiment of the present invention includes modularized dedicated calculation devices which each receive a command word via a command word bus and decode the command word using its built-in decoder to perform an instructed operation. Thus, the voice recognition device according to an embodiment of the present invention improves performance and thus can sufficiently perform a voice recognition at a low speed clock.

An observation probability calculation device according to an embodiment of the present invention can efficiently perform an observation probability calculation which is required the most frequently using a hidden Markov model search method.

A dedicated observation probability calculating device for performing the hidden Markov model search method increases the speed of voice recognition and can reduce the number of used command words by 50% of that when the dedicated observation probability calculating device is not used. Thus, if an operation is performed for a predetermined period of time, the operation can be achieved at a low clock speed with halved power.

In addition, the dedicated observation probability-calculating device can use probabilistic calculations based on a hidden Markov model.

An FFT calculation device according to an embodiment of the present invention can reduce the number of cycles required for an FFT calculation to 4-5 cycles, thus minimizing a time required for an FFT calculation.

In addition, since the FFT calculation device according to an embodiment of the present invention can maintain a compatibility with a general-purpose 3-bus system, an LSI system can be easily applied to an IP, thus providing a great industrial effect.

A cache according to an embodiment of the present invention minimizes the period of time required for a real-time processing system to respond to an interrupt. Also, the cache according to an embodiment of the present invention can perform various caching methods using a hardware/software control method.

Furthermore, since the cache according to an embodiment of the present invention can be implemented in a relative small logic circuit, the productivity can be improved, and the manufacturing costs can be reduced.

What is claimed is:

1. A voice recognition device which extracts a determined sound section from an input voice signal, extracts feature values used for a voice recognition from the determined sound section, compares the feature values with feature values of a pre-stored word, and recognizes a word having the greatest probability as an input voice, the voice recognition device comprising:
a CODEC (coder/decoder) for sampling a voice signal received from a microphone and blocking and outputting sampled data at intervals of a predetermined time;
a register file unit for buffering data blocks received from the CODEC corresponding to the determined sound section;
a fast Fourier transform (FFT) unit for either transforming the data blocks received from the register file unit into a frequency domain or performing an inverse operation to the conversion into the frequency domain and storing a result of the conversion in the register file unit;
an observation probability calculation module for calculating an observation probability by comparing the feature values extracted from the input voice signal with the feature values of phonemes of a pre-stored word on the basis of a frequency spectrum obtained by the FFT unit;
a program memory for extracting data blocks corresponding to the determined sound section from the data blocks output from the CODEC, storing the extracted data blocks in the register file unit, calculating feature values for a hidden Markov model from the frequency spectrum stored in the register file unit, and storing a voice recognition program based on observation probabilities of individual phonemes calculated by the observation probability calculation module; and
a control unit for controlling operations of the voice recognition device using the voice recognition program stored in the program memory.

2. The voice recognition device of claim 1, further comprising:
two read buses;
one write bus; and
a command word bus for transmitting a command to the voice recognition device.

3. The voice recognition device of claim 2, wherein the FFT unit and the observation probability calculation module each have a controller for decoding a command word received via the command word bus and controlling an operation designated by the command word to be executed.

4. The voice recognition device of claim 1, further comprising a cache for reading a series of command words expected to be required next from the program memory, storing the command words, and providing the command words to the control unit.

5. The voice recognition device of claim 4, wherein the command words stored in the cache are interrupt vectors and interrupt service routines.

6. The voice recognition device of claim 4, wherein upon initialization, the cache is initialized to load the command words stored in a predetermined area of the program memory.

7. The voice recognition device of claim 4, wherein a program for controlling the cache is loaded in the program memory and controls the cache to perform a block exchange.

8. The voice recognition device of claim 1, further comprising a memory interface for interfacing programs and data provided from an external memory.

9. The voice recognition device of claim 8, further comprising an external interface which receives requests from the voice recognition device to access the external memory, prioritizes the requests, and connects the voice recognition device to the external memory according to the priority of the requests.

10. The voice recognition device of claim 1, further comprising a multiply and accumulation unit which operates in connection with the observation probability calculation module and repeatedly performs a multiplication and an accumulation required to compute an observation probability.

11. The voice recognition device of claim 1, further comprising a clock generator for generating a clock signal to be provided to the voice recognition device, wherein the clock generator decreases a frequency of the clock signal to achieve a low power consumption.

12. An observation probability calculation device for use in a voice recognition device, the observation probability calculation device for calculating probabilities that phonemes of a predetermined word can be each observed upon voice recognition, the observation probability calculation device comprising:
a memory for storing a mean of parameters extracted from phoneme samples and a distribution degree (1/σ) of the mean, wherein the distribution degree is a precision;
a subtractor for calculating the difference between the mean received from the memory and a feature extracted from a voice signal to be recognized; and
a multiplier for multiplying an output of the subtractor by the distribution degree received from the external memory.

13. The observation probability calculation device of claim 12, wherein, when i denotes an index representing a representative type of a phoneme and j denotes an index representing a number of parameters of a phoneme, the external memory stores precision [i][j] and mean [i][j] and provides them to the subtractor in a predetermined sequence, the subtractor calculates the difference between the mean [i][j] and a feature [i][j] in the predetermined sequence, and the multiplier multiplies the precision [i][j] by the difference calculated by the subtractor in the predetermined sequence.

14. The observation probability calculation device of claim 13, further comprising a squarer for squaring the result of the multiplication performed by the multiplier.

15. The observation probability calculation device of claim 14, further comprising registers buffering the precision [i][j], the mean [i][j], and the feature [i][j], respectively.

16. The observation probability calculation device of claim 14, further comprising an accumulator for accumulating an output of the squarer.

17. The observation probability calculation device of claim 16, further comprising a register buffering the result of the accumulation performed by the accumulator.

18. A complex FFT (fast Fourier transform) calculation device which computes a complex FFT of first complex data composed of a first real number and a first imaginary number and a complex FFT of second complex data composed of a second real number and a second imaginary number, the complex FFT calculation device comprising:
first and second input registers for loading the first and second real numbers and the first and second imaginary numbers;
first and second coefficient registers for loading a sine coefficient and a cosine coefficient, respectively;
an adder and a subtractor for operating an addition and a subtraction, respectively, with respect to the values stored in the first and second input registers;
first and second multipliers for multiplying the output of the subtractor by the output of the first coefficient register and the output of the subtractor by the output of the second coefficient register, respectively;
first and second storage registers for storing the output of the first multiplier and third and fourth storage registers for storing the output of the second multiplier;
first and second multiplexers for controlling paths of the outputs of the first through fourth storage registers provided to the adder and the subtractor, respectively;
an output register for storing the result of the FFT calculation;
a third multiplexer for providing one of the output of the adder and the output of the subtractor to the output register; and
a controller for controlling selection operations of the first through third multiplexers, the addition operation of the adder, the subtraction operation of the subtractor, the multiplication operation of the multiplier, and the storage operations of the first through fourth storage registers.

19. The complex FFT calculation device of claim 18, further comprising:
a first read bus for providing the first real number or the first imaginary number to the first input register and providing the sine coefficient to the first coefficient register;
a second read bus for providing the second real number or the second imaginary number to the second input register and providing the cosine coefficient to the second coefficient register; and
a write bus for outputting one of a real number part and an imaginary number part that form a resultant complex FFT value loaded in the output register.

20. A method of calculating a complex (fast Fourier transform) FFT of first complex data composed of a first real number and a first imaginary number and a complex FFT of second complex data composed of a second real number and a second imaginary number, the method comprising the steps of:
(a) loading a sine coefficient and a cosine coefficient in first and second coefficient registers, respectively, via first and second read buses, respectively;
(b) loading the first real number in a first input register via the first read bus, loading the second real number in a second input register via the second read bus, calculating a difference between the first and second real numbers using a subtractor, multiplying the output of the subtractor by the sine coefficient of the first coefficient register, storing the result of the multiplication in a first storage register, multiplying the output of the subtractor by the cosine coefficient of the second coefficient register, and storing the result of the multiplication in a second storage register;
(c) loading the first imaginary number in the first input register via the first read bus, loading the second imaginary number in second input register via the second read bus, calculating a difference between the first and second imaginary numbers using the subtractor, multiplying the output of the subtractor by the sine coefficient of the first coefficient register, storing the result of the multiplication in a third storage register, multiplying the output of the subtractor by the cosine coefficient of the second coefficient register, and storing the result of the multiplication in a fourth storage register;
(d) calculating a difference between the value stored in the second storage register and the value stored in the third storage register using the subtractor to obtain a real number part of a complex FFT and storing the real number part in an output register; and
(e) calculating a sum of the value stored in the first storage register and the value stored in the fourth storage register using the adder to obtain an imaginary number part of a complex FFT and storing the imaginary number part in the output register.

21. The method of claim 20, further comprising the step of (f) loading a coefficient to be used for a next operation in the first and second coefficient registers during step (d) or step (e).

22. The method of claim 20, wherein steps (a) through (e) are each performed within one cycle.

23. The method of claim 20, wherein in step (a), the sine coefficient is loaded in the first coefficient register via the first read bus, and the cosine coefficient is loaded in the second coefficient register via the second read bus.

24. The method of claim 20, wherein in step (b), the first real number is loaded in the first input register via the first read bus, and the second real number is loaded in the second input register via the second read bus.

25. The method of claim 20, wherein in step (c), the first imaginary number is loaded in the first input register via the first read bus, and the second imaginary number is loaded in the second input register via the second read bus.

26. The method of claim 20, further comprising the step of (g) loading coefficients every time a data block is subjected to an FFT calculation in each of (N/2)log(N) stages that constitute the complex FFT calculation, wherein N denotes the number of data of each data block, and the number of data blocks required in a current stage is twice the number of data blocks required in the previous stage.

27. The method of claim 20, further comprising the step of (h) loading coefficients required in each stage and referring to the loaded coefficients every time a data block is subjected to an FFT calculation, wherein the complex FFT calculation is composed of (N/2)log(N) stages where N denotes the number of data of each data block, and the number of data blocks required in a current stage is twice the number of data blocks required in the previous stage.

28. A recording medium which stores a computer program for calculating a complex FFT of first complex data composed of a first real number and a first imaginary number and a complex FFT of second complex data composed of a second real number and a second imaginary number, the computer program comprising the steps of:
(a) loading a sine coefficient and a cosine coefficient in first and second coefficient registers, respectively, via first and second read buses, respectively;
(b) loading the first real number in a first input register via the first read bus, loading the second real number in second input register via the second read bus, calculating a difference between the first and second real numbers using a subtractor, multiplying the output of the subtractor by the sine coefficient of the first coefficient register, storing the result of the multiplication in a first storage register, multiplying the output of the subtractor by the cosine coefficient of the second coefficient register, and storing the result of the multiplication in a second storage register;
(c) loading the first imaginary number in the first input register via the first read bus, loading the second imaginary number in the second input register via the second read bus, calculating a difference between the first and second imaginary numbers using the subtractor, multiplying the output of the subtractor by the sine coefficient of the first coefficient register, storing the result of the multiplication in a third storage register, multiplying the output of the subtractor by the cosine coefficient of the second coefficient register, and storing the result of the multiplication in a fourth storage register;
(d) calculating a difference between the value stored in the second storage register and the value stored in the third storage register using the subtractor to obtain a real number part of a complex FFT and storing the real number part in an output register; and
(e) calculating a sum of the value stored in the first storage register and the value stored in the fourth storage register using the adder to obtain an imaginary number part of a complex FFT and storing the imaginary number part in the output register.

29. A cache which reads a series of data expected to be required next by a central processing unit from an external memory, stores the data, and is primarily accessed before the central processing unit accesses the external memory, the cache comprising:
an internal memory for storing data stored in the external memory and addresses of the data stored in the external memory;
a comparator for comparing external addresses used to access the external memory with the external addresses stored in the internal memory to generate an equivalence detection signal that represents either equivalence or nonequivalence;
an address converter for generating an internal address used to access the internal memory, on the basis of the external address used to access the external memory, a write address received from a command word storage controller, and an upper address of each of the external addresses and for generating an internal memory read/write control signal; and
the command word storage controller for controlling data stored in the external memory to be loaded in the internal memory, wherein the control is made voluntarily or in response to a command received from outside of the cache.

30. The cache of claim 29, wherein the comparator comprises:
representative address registers each storing a head address among the external addresses stored in each of memory blocks into which the internal memory is blocked; and
representative address comparators for comparing the external addresses used to access the external memory with the head addresses stored in the representative address registers.

31. The cache of claim 30, wherein the representative address registers each store an upper address of the head address from the external addresses for individual memory blocks of the internal memory.

32. The cache of claim 31, wherein a number of representative address registers and a number of comparators is equal to a number of memory blocks of the internal memory.

33. The cache of claim 32, further comprising an equivalence detector for receiving selection signals from the address comparators and generating the equivalence detection signal representing a cache hit if any of the selection signals represents equivalence.

34. The cache of claim 30, wherein when data stored in the external memory is loaded in the internal memory, external addresses included in the data are stored in the representative address registers under the control of the command word storage controller.

35. The cache of claim 31, wherein when data stored in the external memory is loaded in the internal memory, the upper address of each of the external addresses included in the data is stored in the representative address registers under the control of the command word storage controller.

36. The cache of claim 29, wherein the command word storage controller comprises:
an upper address generator for generating an upper address of each of the external addresses used to access the external memory and providing the upper addresses as representative addresses to the comparator so that the representative addresses are compared in the comparator, when data stored in the external memory is loaded in the internal memory;
a lower address generator for generating a lower address of each of the external addresses used to access the external memory and providing the lower addresses as write addresses to the address converter, when data stored in the external memory is loaded in the internal memory; and
a memory load controller for controlling the upper address generator and the lower address generator voluntarily or in response to an external command word and a control signal so that the data stored in the external memory is loaded in the internal memory, generating a read control signal of the external memory, and controlling the upper addresses generated by the upper address generator to be stored in the comparator.

37. The cache of claim 36, wherein the memory load controller receives the equivalence detection signal from the comparator to determine whether a cache hit occurs, and controls the loading operation of the internal memory if a cache miss occurs.

38. The cache of claim 37, further comprising a write memory block address storage register for storing write block information of the internal memory, wherein the memory load controller performs an internal memory loading operation with reference to the write block information stored in the write memory block address storage register, calculates a write block to be loaded next in the internal memory according to a predetermined rule after the internal memory loading operation is completed, and stores the calculated write block in the write memory block address storage register.

39. The cache of claim 38, further comprising a control mode register for storing control mode information of the memory load controller, wherein if the control mode information stored in the control mode register represents a hardware mode, the memory load controller controls a loading operation of the internal memory depending on a value of the equivalence detection signal.

40. The cache of claim 39, wherein if the control mode information stored in the control mode register represents a hardware mode, the memory load controller ignores the write block information stored in the write memory block address storage register.

41. The cache of claim 37, further comprising a memory block write mode register for storing write mode information of individual memory blocks of the internal memory, wherein the memory load controller controls a loading operation of the internal memory with reference to the write mode information of individual memory blocks stored in the write memory block address storage register, calculates the write mode information of individual memory blocks according to a predetermined rule after the internal memory loading operation is completed, and stores the calculated write mode information of individual memory blocks in the memory block write mode register.

42. The cache of claim 41, further comprising a control mode register for storing control mode information of the memory load controller, wherein if the control mode information stored in the control mode register represents a hardware mode, the memory load controller controls a loading operation of the internal memory depending on a value of the equivalence detection signal, and if the control mode information stored in the control mode register represents a software mode, the memory load controller interprets a command received from outside of the cache and controls a loading operation of the internal memory based on the interpreted command.

43. The cache of claim 42, wherein if the control mode information stored in the control mode register represents a software mode, the memory load controller ignores the write mode information of individual memory blocks stored in the memory block write mode register.

44. The cache of claim 36, wherein the memory load controller is programmed to load predetermined data from the external memory in a predetermined area of the internal memory in response to an initial load signal.

45. The cache of claim 36, further comprising a controller for interpreting the command and generating a control signal for controlling the memory load controller.

46. A system comprising:
a main memory for loading a program necessary to operate the system and a cache control program;
a central processing unit for controlling the operation of the system according to the program stored in the main memory; and
a cache for reading a series of data expected to be required next by the central processing unit from the main memory, storing the series of data, and being accessed before the main memory is accessed by the central processing unit, the cache comprising:
an internal memory for storing data stored in the main memory and addresses of the data stored in the main memory;
a comparator for comparing external addresses used to access the main memory with the external addresses stored in the internal memory to generate an equivalence detection signal that represents either equivalence or nonequivalence;
an address converter for generating an internal address used to access the internal memory, on the basis of the external address used to access the main memory, a write address received from a command word storage controller, and an upper address of each of the external addresses and for generating an internal memory read/write control signal; and
the command word storage controller for controlling data stored in the main memory to be loaded in the internal memory, wherein the control is made voluntarily or in response to a command received from outside of the cache.

47. A cache controlling method of a cache which reads a series of data expected to be required next by a central processing unit from an external memory, stores the series of data, and is accessed before the external memory is accessed by the central processing unit, the method comprising the steps of:
setting an updating pointer for pointing to an arbitrary area of an internal memory of the cache;
setting a value of the updating pointer by calculating a block to be exchanged with a block of the external memory from the internal memory of the cache; and
exchanging the internal memory of the cache with the external memory on a block-by-block basis starting from the area of the internal memory pointed to by the updating pointer.

48. The cache controlling method of claim 47, further comprising the step of:
setting the cache so as to be exchanged with the external memory starting from the area of the internal memory pointed to by the updating pointer if a cache miss occurs in the cache.

49. The cache controlling method of claim 47, further comprising the step of generating a command composed of an operand indicating a block exchange with respect to the cache, a destination representing an area of the cache to be exchanged, and a source representing an area of the external memory to be exchanged.
